(19) United States
(12) Patent Application Publication
(10) Pub. No.: US 2026/0234346 A1
(43) Pub. Date: Aug. 13, 2026

(54) CROSSLINKABLE POLYMER COMPOSITION, CROSSLINKED POLYMER MATERIAL, INSULATED ELECTRIC WIRE, AND WIRING HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(72) Inventors: Masashi SATO, Yokkaichi-shi (JP); Takehiro HOSOKAWA, Yokkaichi-shi (JP); Tatsuya SHIMADA, Yokkaichi-shi (JP); Katsushi SAKAMOTO, Yokkaichi-shi (JP); Makoto MIZOGUCHI, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRICI NDUSTRIES, LTD., Osaka-shi, Osaka (JP); KYUSHU UNIVERSITY, NATIONAL UNIVERSITY CORPORATION, Fukuoka-shi, Fukuoka (JP)

(21) Appl. No.: 19/154,935

(22) PCT Filed: Feb. 13, 2024
(86) PCT No.: PCT/JP2024/004778

§ 371 Date: Aug. 8, 2025

(30) Foreign Application Priority Data
Feb. 10, 2023 (JP) 2023-019216

(51) Int. Cl. C08J 3/24; C08F 8/44; C08K 5/17; C08K 5/18; H01B 7/00

(52) U.S. Cl. CPC C08J 3/247; C08F 8/44; C08K 5/17; C08K 5/18; H01B 7/0045; C08F 2810/20; C08J 2323/08; C08J 2323/30; C08J 2353/02

(57) ABSTRACT

Provided are a crosslinkable polymer composition capable of forming a crosslinked structure by heating and capable of allowing a transition into a state having high heat-moldability from a state having low moldability at a certain temperature, a crosslinked polymer material obtained by crosslinking of the crosslinkable polymer composition, and an insulated electric wire and a wiring harness provided with the crosslinked polymer material.

A crosslinkable polymer composition includes: ingredient A from which a metal ion is released upon heating; ingredient B composed of an organic polymer having a side chain including an electron-withdrawing substituent group capable of forming an ionic bond with the metal ion released from ingredient A; and ingredient C composed of a compound having a structure represented by formula (1) below and having a melting point of 190° C. or higher. The metal ion released from ingredient A crosslinks ingredient B to form a crosslinked product having a flow starting temperature of 190° C. or higher:

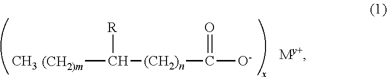

where R represents a hydrogen atom or a hydroxyl group; m+n is 11 or more and 30 or less; and M^{y+} represents a y-valent metal ion.

### TECHNICAL FIELD

The present disclosure relates to a crosslinkable polymer composition, a crosslinked polymer material, an insulated electric wire, and a wiring harness.

### BACKGROUND ART

In an insulated electric wire and a wiring harness, a thermoplastic polymer composition is often used as an insulation member, such as an insulation coating which covers an outer periphery of a wire conductor. When the thermoplastic polymer composition is molded into a desired shape, the composition is heated to have fluidity, and then a forming method, such as an extrusion molding method, is applied. To mold the composition easily and conveniently by heating, it is preferable that the polymer composition acquires fluidity without heating to an extremely high temperature.

Meanwhile, in the insulated electric wire and the wiring harness, temperature rise is caused by application of electric current, and therefore, high heat resistance is required for a polymer composition, such as the insulation coating placed in the vicinity of a portion where the current is applied. That is, the polymer composition is required not to undergo irreversible deformation by heat generated by the application of current. For example, an insulation coating of an electric wire for an automobile is desired not to undergo irreversible deformation at temperatures below 190° C. Especially, in an electric wire for conducting current in an electric vehicle, it is necessary for the wire conductor to conduct a large current. As a result, a large amount of heat is generated when the current is applied, and therefore, the polymer composition constituting the insulation coating is required to have high heat resistance.

Thus, in the polymer composition used for the insulated electric wire and the wiring harness, it is required to be moldable relatively easily by heating and to have high heat resistance after it is molded. One method for satisfying both properties is to adjust a flow starting temperature of the thermoplastic polymer material to be used. However, this method has a limitation in that a polymer material with a high flow starting temperature requires heating to a high temperature during molding, while a polymer material with a low flow starting temperature is unlikely to have high heat resistance. Here, the crosslinking of the polymer composition is also employed as another method. Specifically, an uncrosslinked polymer composition is molded into a desired shape by extrusion molding and then molecular chains of the composition is crosslinked to improve heat resistance. A method of crosslinking include electron-beam crosslinking (disclosed in Patent Document 1, for example) in which a material molded with polyolefin is irradiated with electron beams to crosslink the molecular chains of the polymer into a network structure, and silane crosslinking (disclosed in Patent Document 2, for example) in which a thermoplastic resin into which an active silane group has been introduced is molded and then crosslinked by contact with moisture. Crosslinking by vulcanization can be used when a rubber is used as a polymer material.

The electron-beam crosslinking and the silane crosslinking, and the crosslinking by vulcanization require equipment, such as an electron beam irradiator or a humidity exposure device, and a vulcanizer. Meanwhile, as proposed by the present inventors in Patent Literature 3 for example, if a metal-crosslinkable polymer composition containing ingredient A, which releases a metal ion upon heating, and ingredient B, which is composed of an organic polymer having a substituent group capable of forming an ionic bond with the metal ion released form ingredient A, is used, then the metal ion released from ingredient A upon heating forms an ionic bond with the substituent group of ingredient B, whereby the organic polymer contained in ingredient B is crosslinked via the ionic bond.

### PRIOR ART REFERENCES

### Patent Literature

Patent Literature 1: JP 2020-176257
Patent Literature 2: JP 2020-161398
Patent Literature 3: WO 2021/193811

### SUMMARY OF INVENTION

### Technical Problem

The organic polymer composing ingredient B used primarily in Patent Literature 3 is mainly a resin in a liquid state at room temperature or at 150° C. or lower, and the metal-crosslinked polymer material is obtained by applying the metal-crosslinkable polymer composition containing ingredient A and ingredient B mixed together on the surface of a metal material and then heating. Here, when the liquid resin is replaced by the thermoplastic resin having a flow starting temperature at a relatively high temperature, such as 190° C. or higher as the organic polymer, the metal-crosslinkable polymer composition can be molded into a desired shape, such as a shape of the insulation coating of the electric wire, using a heat molding method, such as extrusion molding. By heating the formed body to be subjected to a metal-crosslinking, it is expected to obtain the crosslinked polymer material with excellent heat resistance.

However, when the metal-crosslinkable composition containing the thermoplastic resin is heated to a high temperature, such as 190° C. or higher for kneading and heat molding of the composition, the metal ion is released from ingredient A and the metal-crosslinking reaction can be initiated with ingredient B. Then, deformability of the composition can be low. In other words, even if the composition is subjected to the heat molding, such as extrusion molding, the deformation of the composition might not progress easily into a desired shape. When the deformability of the composition is lowered at the time of heating, the composition can not be heat-molded, or the forming speed can not be accelerated when the composition can be heat-molded. As a result, the amount of the formed product formed within a certain period of time is likely to be small, resulting in decreased production efficiency and excessive energy consumption.

From the viewpoint of heat-moldability, it is desired that the material to be formed maintains high heat-moldability at a temperature at which the heat molding is performed, i.e., 190° C. or higher, for example, as described above. Meanwhile, from the viewpoint of enhancing the heat resistance of the formed body obtained as a result of the heat molding, it is preferable that the material without being heated to a high temperature maintains a low heat-moldability at the temperature below 190° C., for example. Particularly, when the polymer material for applications subjected to heat, including the insulation coating of the electric wire, is manufactured via heat molding, it is preferable that a material that has low heat-deformability at a temperature lower than the forming temperature is used, while having high heat deformability at a temperature of the forming temperature or higher.

In view of the above, an object is to provide a crosslinkable polymer composition capable of forming a crosslinked structure by heating and capable of allowing a transition into a state having high heat-moldability from a state having low heat-moldability at a certain temperature, a crosslinked polymer material obtained by crosslinking of the crosslinkable polymer composition, and an insulated electric wire and a wiring harness including the crosslinked polymer material.

### Solution to Problem

A crosslinkable polymer composition contains ingredient A from which a metal ion is released upon heating, ingredient B composed of an organic polymer having a side chain containing an electron-withdrawing substituent group capable of forming an ionic bond with the metal ion released from ingredient A, and ingredient C composed of a compound having a structure represented by the following formula (1) and a melting point of 190° C. or higher. The metal ion released from ingredient A crosslinks ingredient B to form a crosslinked product having a flow starting temperature of 190° C. or higher:

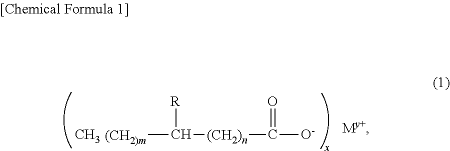

where R represents a hydrogen atom or a hydroxyl group; each of m and n independently represents an integer of 1 or more; m+n is 11 or more and 30 or less; and M^{y+} represents a y-valent metal ion, where y is an integer of 1 or more and x=y.

A crosslinked polymer material according to the present disclosure is composed of a material formed by crosslinking of the crosslinkable polymer composition, containing a crosslinked product in which ingredient B was crosslinked via the metal ion released from ingredient A, and ingredient C.

An insulated electric wire according to the present disclosure includes a wire conductor, and an insulation coating containing the crosslinked polymer material, covering the wire conductor.

A wiring harness according to the present disclosure includes the insulated electric wire.

### Advantageous Effects of Invention

The crosslinkable polymer composition according to the present disclosure is capable of forming the crosslinked structure by heating and capable of allowing the transition into a state having high heat-moldability from a state having low heat-moldability at a certain temperature. The crosslinked polymer material is obtained by crosslinking of the crosslinkable polymer composition. The insulated electric wire and the wiring harness according to the present disclosure include the crosslinked polymer material.

### BRIEF DESCRIPTION OF DRAWINGS

FIGS. 1A to 1C illustrate behaviors of crosslinked products included in the crosslinked polymer material according to one embodiment of the present disclosure when the crosslinked product is heated. FIGS. 1A, 1B, and 1C indicate states that the temperature increases in this order. M²⁺ represents a metal ion, and R represents a side chain (these are unrelated to M and R in formula (1)).

FIG. 2 illustrates a cross-sectional view of the structure of an insulated electric wire according to one embodiment of the present disclosure.

FIG. 3 illustrates a change in infrared absorption spectra measured while kneading a composition containing ingredients A, B, and C. Here, each spectrum during kneading is represented as a difference spectrum obtained by subtracting the spectrum of a composition in which ingredient C is absent. Additionally, an infrared absorption spectrum of ingredient C alone is shown at the top for reference.

### DESCRIPTION OF EMBODIMENTS

### Description of Embodiments of Present Disclosure

Embodiments of the present disclosure are now enumerated and described. A crosslinkable polymer composition, a crosslinked polymer material, an insulated electric wire and a wiring harness according to the present disclosure have the following structures.

[1] The crosslinkable polymer composition according to the present disclosure contains ingredient A from which metal ion is released upon heating, ingredient B composed of an organic polymer having a side chain containing an electron-withdrawing substituent group capable of forming an ionic bond with the metal ion released from ingredient A, and ingredient C composed of a compound having a structure represented by the following formula (1) and a melting point of 190° C. or higher, wherein when ingredient B is crosslinked via the metal ion released from ingredient A to form a crosslinked product, the crosslinked product has a flow starting temperature of 190° C. or higher:

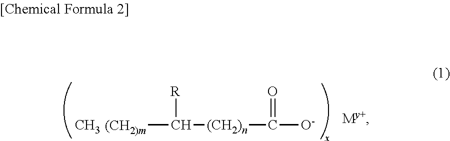

where R represents a hydrogen atom or a hydroxyl group; each of m and n independently represents an integer of 1 or more; m+n is 11 or more and 30 or less; and M^{y+} represents a y-valent metal ion, where y is an integer of 1 or more and x=y.

In the crosslinkable polymer composition according to the present disclosure, ingredient B can be crosslinked via the metal ion released from ingredient A upon heating. Therefore, while the composition has high moldability in the form of an uncrosslinked composition, a polymer material with high heat resistance can be easily obtained by forming a crosslinked product through heating. Especially, if the flow starting temperature of the crosslinked product is 190° C. or higher, a crosslinked polymer material is ensured to have high heat resistance. A material having a flow starting temperature of 190° C. or higher with high heat resistance can be used particularly suitably for constituting an insulation coating of an electric wire in an automobile. Furthermore, in the crosslinkable polymer composition according to the present disclosure, since a crosslinked structure is formed by the ionic bond, flexibility of the polymer material is less likely to decrease due to the crosslinking compared to a case where a crosslinked structure is formed by a covalent bond. Therefore, the polymer material is not easily hardened due to the crosslinking, and the flexibility in bending of the insulation coating is less likely to decrease even when an insulation coating of an electric wire having a large diameter is formed, for example.

Furthermore, the crosslinkable polymer composition according to the present disclosure contains ingredient C composed of a compound having the structure of formula (1) mentioned above, and ingredient C melts into a liquid state and improves fluidity of the crosslinked product formed from ingredients A and B, thereby improving the heat deformability of the crosslinkable polymer composition. As a result, ingredient C improves the heat-moldability of the crosslinkable polymer composition. Therefore, when the crosslinkable polymer composition is kneaded to be heat-molded by a method, such as extrusion molding, ingredient C contributes to maintaining a highly fluid state of the composition even when the crosslinked product is already formed from ingredients A and B in a state before or during forming. As a result, the composition is easily heat-molded into a desired shape. Since ingredient C can improve the heat-moldability only in a liquid state, ingredient C can make the crosslinkable polymer composition transition into a state having high heat-deformability at a temperature of the melting point of ingredient C within a range of high temperature. Meanwhile, while the improvement of the heat-moldability of ingredient C is a reversible phenomenon, ingredient C, having the melting point of 190° C. or higher, maintains a hardly deformable state of the crosslinked polymer material at a temperature below 190° C., exhibiting high heat resistance.

Furthermore, in the crosslinked product formed from the crosslinkable polymer composition of the present disclosure, since the crosslinked structure is formed via the ionic bond formed between the substituent group included in the organic polymer composing ingredient B and the metal ion, the crosslinked polymer material can be re-molded upon heating, using the reversibility of the ionic bond. This is because each crosslinking point as a result of the ionic bond moves when the already-formed crosslinked product is heated again, and fluidization of the material occurs. Here, if the substituent group introduced into the organic polymer contained in ingredient B is the electron-withdrawing group, the crosslinked structure is stably formed and the crosslinked product exhibits high heat resistance. Meanwhile, because the substituent group is introduced into the side chain of the organic polymer, the degree of freedom of thermal motion is enhanced at the crosslinking site, and movements of the crosslinking points are likely to occur during heating. As a result, excellent re-moldability is exhibited. Furthermore, since the crosslinkable polymer composition contains ingredient C which improves the heat-moldability, the crosslinked product can be re-molded simply by heating the crosslinked product to the melting point of ingredient C or higher during it is remolded, by taking advantage of the effect of ingredient C. Since the fluidization of the crosslinked product and the improvement of the fluidity of the crosslinked product by ingredient C are both reversible phenomena, the shape of the crosslinked product after being re-molded can be kept stable by stopping heating and cooling the crosslinked product.

[2] In embodiment [1], the melting point of ingredient C and the flow starting temperature of the crosslinked product are preferably 300° C. or lower. Then, the material once crosslinked can be transitioned into a state having high fluidity by being heated at 300° C. or lower, ensuring high re-moldability at 300° C. or lower.

[3] In embodiments [1] or [2], ingredient A preferably has a decomposition or phase transition temperature lower than the flow starting temperature of ingredient C. Then, it is possible to form the crosslinkable polymer composition into a desired shape by heat molding, such as extrusion molding, while forming the crosslinked product between a metal ion released from ingredient A and ingredient B by heating the crosslinkable polymer composition at the melting point of ingredient C or higher. In this process, although heat molding, such as extrusion molding is to be performed in a state at which the crosslinked product has already been formed, the coexistence of ingredient C in a melted state with the crosslinked product improves fluidity of the crosslinked product, and high heat-moldability is obtained. Therefore, the crosslinked product can be formed smoothly into a desired shape.

[4] In any one of embodiments [1] to [3], ingredient A preferably has a decomposition or phase transition temperature at 50° C. or higher and 300° C. or lower. Then, a releasing of the metal ion from ingredient A is suppressed during the preparation of the crosslinkable polymer composition or prior to use of the crosslinkable polymer composition, whereby the progression of crosslinking is suppressed. As a result, the crosslinkable polymer composition can acquire high storage stability, including a suppression of a quality change at low temperatures, such as room temperature. Meanwhile, since ingredient A is likely to undergo decomposition or phase transition and releasing easily of the metal ion at a moderate temperature, a crosslinking reaction can progress at a temperature that does not cause quality change of ingredient B.

[5] In any one of embodiments [1] to [4], ingredient C preferably satisfies the formula x=y=1. In this case, when ingredient C is monovalent, ingredient C has high melting point and the crosslinked product formed by crosslinking obtains high heat resistance. Furthermore, even if the crosslinkable polymer composition is heated at a high temperature, ingredient C does not cause crosslinking in ingredient B, and therefore, ingredient C is less likely to influence the formation of the crosslinked structure of ingredient B by ingredient A and the fluidity of ingredient B.

[6] In any one of embodiments [1] to [5], ingredient B preferably has the flow starting temperature of 50° C. or higher and 190° C. or lower. Then, it is likely to obtain the crosslinked product having the flow starting temperature of 190° C. or higher and 300° C. or lower through crosslinking via the metal ion derived from ingredient A. Furthermore, when an uncrosslinked crosslinkable polymer composition is molded into a desired shape by extrusion molding, the composition can acquire high formability by ingredient C, which improves the heat deformability.

[7] In any one of embodiments [1] to [6], ingredient A preferably has a decomposition or phase transition temperature equal to or higher than the flow starting temperature of ingredient B. Then, the metal ion is released from ingredient A and the accompanying crosslinking of ingredient B occurs, in the state where ingredient B has fluidity. Therefore, dispersibility of ingredient A in ingredient B can be improved by taking advantage of the flow of ingredient B. As a result, it is possible to obtain a crosslinked product having crosslinking points with high spatial uniformity. Furthermore, unintentional release of the metal ion from ingredient A and the accompanying progress of crosslinking of ingredient B are unlikely to occur during preparation and formation of the crosslinkable polymer composition.

[8] In any one of embodiments [1] to [7], ingredient A may be a metal complex including a ligand having the structure represented by formula (2) below.

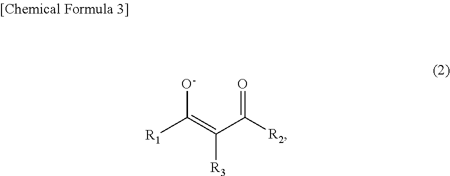

where each of R₁ and R₂ independently represents a hydrocarbon group having 1 to 8 carbon atoms, and R₃ represents a hydrogen atom or a hydrocarbon group having 1 to 8 carbon atoms, including a case where at least two among groups R₁, R₂, R₃ are interconnected by a ring structure.

A β-diketonato ligand represented by formula (2) is a bidentate ligand which is more effective in stabilizing the metal ion than a monodentate ligand or a ligand that forms a bridging coordination structure, and therefore, the releasing of the metal ion from ingredient A is suppressed during the preparation of the crosslinkable polymer composition and prior to use of the crosslinkable polymer composition. As a result, it is possible to obtain particularly high storage stability.

[9] In any one of embodiments [1] to [8], the metal ion released from ingredient A is preferably at least one selected from the group consisting of alkaline-earth, aluminum, zinc, titanium, and zirconium ions. Each of the metal ions mentioned above is divalent or higher and tends to form a stable crosslinked structure between the polymer chains of ingredient B. Furthermore, each of these metal ions belongs to a hard acid in the HSAB rule and has a high ionization tendency. Correspondingly, a stable bond is formed with the substituent group of ingredient B. For this reason, each of these metals is suitable for forming the crosslinked product.

[10] In any one of embodiments [1] to [9], the substituent group of ingredient B is preferably at least one selected from the group consisting of a carboxylic acid group, an acid anhydride group, a phosphoric acid group, and an acrylic acid group. Each of the substituent groups is one which is likely to form easily the ionic bond with the metal ion released from ingredient A. In addition, because each of the substituent groups belongs to an acidic group that has relatively low polarity, they are less likely to cause phase separation to the main and side chains of ingredient B and can form a crosslinked structure with high spatial uniformity.

[11] In any one of embodiments [1] to [10], the substituent group of ingredient B is preferably bonded to the main chain via an alkyl or alkylene group having one or more carbon atoms. Then, a particularly high degree of freedom of thermal motion is exhibited at the crosslinking site when the composition is heated, and the crosslinking points are more likely to move. As a result, particularly high re-moldability can be obtained.

[12] In any one of embodiments [1] to [11], ingredient B preferably not include an electron-withdrawing group in the main chain. Then, the substituent group included in the side chain is not prevented from forming the ionic bond with the metal ion released from ingredient A due to competition with the electron-withdrawing group in the main chain. Due to steric hindrance, a substituent group in the main chain has difficulty in forming a stable crosslinked structure with the metal ion, and even if the crosslinked structure is formed, the degree of freedom of movement at a crosslinking site is lowered, and high re-moldability is not easily obtained in the crosslinked product. Furthermore, the crosslinked product is unlikely to obtain the effect of improving fluidity by ingredient C.

[13] In any one of embodiments [1] to [12], in the crosslinkable polymer composition, the composition preferably contains ingredient A in an amount of 0.1 part by mass or larger and 30 parts by mass or smaller with respect to 100 parts by mass of a total of ingredients A, B, and C. Then, a sufficient amount of ingredient A allows an increase of a crosslinking density and makes the crosslinkable polymer composition have an excellent crosslinking property. Meanwhile, an influence due to adding of a large amount of ingredient A is likely to be avoided in the material before and after crosslinking.

[14] In any one of embodiments [1] to [13], the crosslinkable polymer composition preferably contains ingredient C in an amount of 1.0 part by mass or larger and 30 parts by mass or smaller with respect to 100 parts by mass of the total of ingredients A, B, and C. Then, ingredient C in a liquid state improves significantly the heat deformability of the crosslinkable polymer composition. Meanwhile, as long as the composition contains ingredient C within the amount mentioned above, ingredient C is less likely to cause phenomena including a deterioration of physical properties, such as material strength, low-temperature characteristics, or an increase in elastic modulus, which can be caused if a large amount of ingredient C is contained in the crosslinked material.

[15] The crosslinked polymer material according to the present disclosure is composed of a material formed by crosslinking of the crosslinkable polymer composition according to any one of embodiments [1] to [14]. The crosslinked polymer material contains the crosslinked product in which ingredient B is crosslinked via the metal ion released from ingredient A, and ingredient C. Because the crosslinked product, which is formed by crosslinking of ingredient B via the metal ion released from ingredient A, has the crosslinking points at positions of the electron-withdrawing substituent group introduced into the side chain of ingredient B and the flow staring temperature of 190° C. or higher, the crosslinked polymer material has both high heat resistance and re-moldability by heating. Furthermore, the flexibility is less likely to be lowered due to the crosslinking. While most of ingredient C is left in the crosslinked polymer material without being incorporated into the crosslinked structure, ingredient C contributes to improving of the heat-moldability of the crosslinkable polymer composition if the crosslinkable polymer composition is heated to the melting point of ingredient C or higher. Therefore, the crosslinked polymer material can acquire high moldability when it is molded into a desired shape or when it is re-molded. On the other hand, because the melting point of ingredient C is 190° C. or higher, the heat deformability of the crosslinked polymer material does not improve at a temperature lower than 190° C., and therefore, the crosslinked polymer material maintains its shape stably and exhibits high heat resistance.

[16] The insulated electric wire according to the present disclosure constitutes a wire conductor and the insulation coating composed of the crosslinked polymer material according to embodiment [15] described above and covering the outer periphery of the wire conductor. In the insulated electric wire, the insulation coating is composed of the crosslinked polymer material according to the disclosure mentioned above, and therefore, the insulated electric wire has high heat resistance. Furthermore, the insulated electric wire is less likely to cause irreversible deformation even if the wire conductor is heated by the application of the current. Meanwhile, by heating the insulation coating to a temperature sufficient to fluidize it again, the insulation coating can be re-molded, and the shape of the insulation coating can be changed. For example, when the wire conductor is deformed, the insulation coating can also be deformed easily while following the shape of the wire conductor. In particular, since the crosslinked polymer material contains ingredient C, it is possible to use the effect of ingredient C, which improves the heat deformability of the crosslinkable polymer composition, for forming the insulation coating by extrusion molding and a re-molding of the insulation coating by heating, with high efficiency. Furthermore, because the flexibility of the material is less likely to be lowered by crosslinking, the insulation coating can be formed to have high flexibility and the insulated electric wire can be routed easily, involving bending, even when the electric wire is formed to have a large diameter.

[17] In embodiment [16] described above, the wire conductor preferably includes a plurality of elemental wires twisted together, and the insulated electric wire preferably has a flat portion in which a cross-section of the wire conductor perpendicular to an axial direction has a flat shape. An electric wire having a flat portion is required from the viewpoint of space saving. The flat portion is formed easily by taking advantage of the re-moldability of the insulation coating, such that a conventional insulated electric wire having a circular cross section is subjected to a compression force into a flat shape, while heating the insulation coating. Conversely, the insulated electric wire having the flat portion can be deformed to have another cross-sectional shape, such as a circular cross-sectional shape, such that the insulated electric wire is subjected to a compression force in a direction that cancels the flat shape of the electric wire, while heating the insulation coating. Accordingly, the insulated electric wire can be easily deformed bi-directionally between a low-flatness state, such as a circular cross-sectional shape, and a flat state, by constituting the insulated electric wire with the wire conductor that includes a plurality of elemental wires twisted together and thus is susceptible to deformation by application of force, and the insulation coating that transitions reversibly into a re-moldable state by heating. For example, various insulated electric wires can be obtained by using a common insulated electric wire and deforming desired parts into desired shapes, such as flat shapes, depending on routing location and application.

[18] A wiring harness according to the present disclosure includes the insulated electric wire according to embodiment [16] or [17] described above. As the insulated electric wire according to the present disclosure includes the insulation coating having excellent heat resistance, excellent moldability during the initial molding and re-molding as described above, the wiring harness can make use of these properties as well.

### DETAILED DESCRIPTION OF EMBODIMENTS OF PRESENT DISCLOSURE

A crosslinkable polymer composition, a crosslinked polymer material, an insulated electric wire, and a wiring harness according to the present disclosure are now described with reference to the drawings. The present disclosure should not be limited to those embodiments.

### [1] Crosslinkable Polymer Composition and Crosslinked Polymer Material

The crosslinkable polymer composition according to the present disclosure contains ingredient A from which a metal ion is released upon heating, ingredient B composed of an organic polymer having a side chain that has an electron-withdrawing substituent group capable of forming an ionic bond with the metal ion released from ingredient A, and ingredient C composed of a compound having a structure represented by formula (1) below and having a melting point of 190° C. or higher:

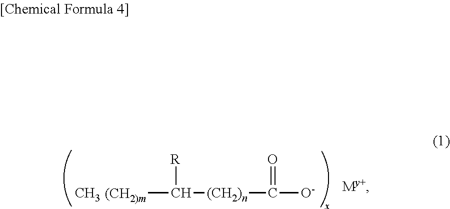

where R represents a hydrogen atom or a hydroxyl group. Each of m and n represents independently an integer of 1 or more; m+n is 11 or more and 30 or less. M^{y+} represents a y-valent metal ion, where y is an integer of 1 or more and a relation of x=y holds.

The crosslinkable polymer composition according to the present embodiment forms the crosslinked polymer material according to the present embodiment by crosslinking ingredient B via the metal ion released from ingredient A by heating, to form a crosslinked product. The crosslinked polymer material contains the crosslinked product and ingredient C. The crosslinked product has a flow starting temperature of 190° C. or higher. In the present disclosure, the crosslinkable polymer composition, which refers basically to a state in which formation of the crosslinked product does not progress, includes a material in a state in which crosslinking has progressed in a certain degree during heat molding including thermal kneading, and extrusion molding.

### (1) Properties of Crosslinkable Polymer Composition and Crosslinked Polymer Material

Before describing each ingredient contained in the crosslinkable polymer composition in detail, properties of the crosslinkable polymer composition and the crosslinked polymer material will be described. The crosslinkable polymer composition according to the present embodiment includes ingredient A from which a metal ion is released upon heating, ingredient B having a substituent group capable of forming an ionic bond with the metal ion, and ingredient C composed of a compound having a structure represented by formula (1) and having a melting point of 190° C. or higher. When the crosslinkable polymer composition containing these ingredients is heated, the metal ion is released from ingredient A. Then, the released metal ion forms an ionic bond with the substituent group of ingredient B, and each organic polymer chain of ingredient B is crosslinked via the ionic bond. Meanwhile, unlike ingredient A, ingredient C is a neutral molecule in which an organic acid moiety is bonded stably to a metal, and therefore, ingredient C rarely releases a metal ion even when it is heated, and the crosslinking of ingredient B rarely occurs via ingredient C or a metal ion released from ingredient C. Ingredient C does not inhibit the crosslinking of ingredient B via the metal ion derived from ingredient A. In the crosslinked polymer material, most of ingredient C coexists with the crosslinked product while maintaining the molecular structure represented by formula (1), without being incorporated into the crosslinked product.

Ingredient A releases the metal ion upon heating. Until ingredient A reaches a temperature at which the metal ion is released as a result of decomposition or phase transition, the metal ion is not released from ingredient A and the crosslinking of the organic polymer composing ingredient B by the formation of the ionic bond does not occur. Therefore, the crosslinkable polymer composition according to the present embodiment can be easily molded into a desired shape by an extrusion molding because the crosslinkable polymer composition has relatively high fluidity at a low temperature at which release of the metal ion from ingredient A and the accompanying crosslinking of ingredient B do not occur. After the crosslinkable polymer composition is molded into a desired shape, the metal ion is released from ingredient A upon heating, and ingredient B is crosslinked to form a crosslinked product. Alternatively, the crosslinkable polymer composition can be molded into a desired shape by extrusion molding after or during the formation, since ingredient C improves the fluidity of the crosslinked product and enhances heat deformability of the crosslinkable polymer composition, as described later.

The crosslinked product has more enhanced heat resistance than the composition that is uncrosslinked since adjacent polymer chains of ingredient B are crosslinked. In the crosslinked product, each organic polymer chain of ingredient B is crosslinked through the ionic bond, and a bonding force, which is stronger than van der Waals force, allows the heat resistance and mechanical strength of the crosslinked product to be effectively improved. On the other hand, the flexibility of the crosslinked product is less likely to be lowered by crosslinking, compared with the case where the crosslinked structure is formed through a covalent bond. In particular, if a highly flexible organic polymer is used as ingredient B, the crosslinked polymer material also has high flexibility.

The crosslinkable polymer composition according to the present embodiment forms the crosslinked polymer material with particularly high heat resistance, when the crosslinked product to be formed has a flow starting temperature of 190° C. or higher. In other words, the crosslinked product is less likely to exhibit increased fluidity and accompanying irreversible deformation at a temperature below 190° C. Here, heat resistance temperature of 190° C. is generally desired for an insulation coating of the insulated electric wire for an automobile, and the crosslinked polymer material according to the present embodiment can be suitably used for constituting the insulation coating of the insulated electric wire for an automobile, as will be described in detail later. From the viewpoint of effectively increasing the heat resistance of the crosslinked polymer material, the flow starting temperature of the crosslinked product is preferably 200° C. or higher, and more preferably 220° C. or higher. The flow starting temperatures of the crosslinked product and ingredient B, explained later, refer to a temperature at which a solid material begins to exhibit fluidity when heated, and can be measured as a temperature at which an indenter can penetrate a sheet of the material, for example, as shown in Examples below. Alternatively, a melting point or a flow point of the material (or the lower one of the two, if both are present) can be regarded as the flow starting temperature.

Furthermore, in the crosslinkable polymer composition according to the present embodiment, a crosslinked structure between the polymer chains of ingredient B is formed by the ionic bond with the metal ion, which is a reversible bond, unlike an irreversible covalent bond, such as the one formed by electron-beam crosslinking or silane crosslinking. Therefore, the crosslinked polymer material to be formed has re-moldability. In other words, when the crosslinked polymer material, once formed via crosslinking, is heated, the material obtains fluidity again. As a result, the crosslinked polymer material can be molded into a shape different from that before heating, by application of external force.

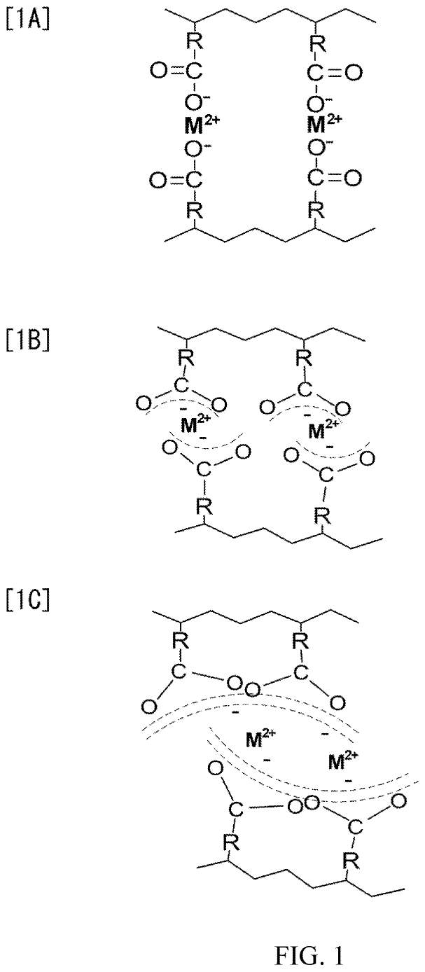

The re-moldability of the crosslinked polymer material can be explained by the mechanism described below. When the crosslinked product in which ingredient B is crosslinked via the metal ion is in an unheated state at or near room temperature, each crosslinking point via the metal ion is localized at a certain position in a chain of ingredient B as shown in FIG. 1A. However, when the crosslinked product is heated, molecular motion of ingredient B is activated by heat, and active thermal motion occurs at and near the crosslinking site at which the ionic bond is formed between the substituent group of ingredient B and the metal ion, as shown in FIG. 1B. When the crosslinked product is heated further to a higher temperature, the molecular motion of ingredient B is activated further, and each crosslinking point via the metal ion can move to a different point (i.e., a position of another substituent group) nearby, resulting in delocalization of each crosslinking point. The delocalization of each crosslinking point forms a state in which a plurality of the substituent groups in the same molecular chain of ingredient B are simultaneously coordinated to one metal ion (i.e., multidentate state), as shown in FIG. 1C. This activation of the thermal motion in ingredient B and the subsequent movement of each crosslinking point allow the crosslinked product to have fluidity. In these states, the crosslinked polymer material can be re-molded by application of an external force to the material appropriately. The activation of the thermal motion at the crosslinking site and delocalization of each crosslinking point are reversible phenomena. Therefore, when the re-molded crosslinked polymer material is cooled, each crosslinking point returns to a localized state, and the crosslinked product returns to the thermally stable state. By repeating heating and cooling, the crosslinked polymer material can be repeatedly re-molded. The activation of the thermal motion at the crosslinking site and delocalization of each crosslinking point caused by heating can be confirmed by infrared absorption spectroscopy, for example. Typically, the activation of the thermal motion at the crosslinking site appears on a spectrum as broadening of absorption peak of the substituent group forming the crosslinked structure, while the delocalization of each crosslinking point appears on the spectrum as growth of a new peak corresponding to the multidentate state.

Furthermore, in the crosslinkable polymer composition according to the present embodiment, the substituent group capable of forming the ionic bond with the metal ion is not present in the polymer main chain but in the side chain in ingredient B. Therefore, the substituent group can acquire a higher degree of freedom of movement at the crosslinking site when the crosslinked structure via the metal ion is formed. Accordingly, the thermal motion at the crosslinking site and movement of each crosslinking point tend to occur more actively in the crosslinked product. Therefore, the crosslinked polymer material shows high re-moldability when it is heated.

Particularly, in the crosslinkable polymer composition according to the present embodiment, the flow starting temperature of the crosslinked product to be formed is preferably suppressed to 300° C. or lower. Then, the crosslinked polymer material can be re-molded by heating to 300° C. at most, and re-molding can be easily performed. From the viewpoint of enhancing the re-moldability effectively, the flow starting temperature of the crosslinked product is preferably 280° C. or lower, and more preferably 250° C. or lower.

The crosslinkable polymer composition according to the present embodiment includes ingredient A from which the metal ion is released upon heating, and ingredient B having the substituent group in the side chain capable of forming the ionic bond with the metal ion, and when ingredient B is crosslinked via the metal ion released from ingredient A to form the crosslinked product, the crosslinked product has the flow starting temperature of 190° C. or higher and 300° C. or lower. Accordingly, the crosslinked polymer material with both high heat resistance and re-moldability can be provided, as described above. The crosslinkable polymer composition according to the present embodiment, having those properties, can be suitably used to constitute a component, such as the insulation coating of an insulated electric wire, which requires high heat resistance and benefits from having re-moldability. Furthermore, as another indicator showing sufficient improvement in heat resistance due to crosslinking, the crosslinked polymer material preferably has a flow starting temperature at least 5° C., and more preferably at least 10° C. higher than the flow starting temperature of ingredient B alone.

The crosslinkable polymer composition according to the present embodiment has high heat resistance and re-moldability by formation of the crosslinked structure through the ionic bond with ingredients A and B, as described above. Furthermore, if the crosslinkable polymer composition contains ingredient C in addition to ingredients A and B, the composition can acquire further enhanced moldability during an initial molding and re-molding while maintaining high heat resistance. Ingredient C has a structure in which a long-chain organic acid and a metal are bonded as represented by formula (1) presented above and works for improving the fluidity of the crosslinked product formed from ingredients A and B at a high temperature. This phenomenon occurs presumably because the bonding force between the long-chain organic acid and the metal in ingredient C is weakened by heat. The organic acid thereby generates a broad anionic field, and the anionic field interacts with a metal-crosslinking site of the crosslinked product formed between the metal ion derived from ingredient A, and ingredient B. Ionic-bonding interaction between the anionic field and the metal ion forming the crosslinked product weakens the bonding force between the metal ion and the substituent group of ingredient B, whereby facilitating the movement of each of the polymer chains of ingredient B which forms the crosslinked product. In other words, delocalization of each crosslinking point, similar to that shown in FIG. 1C, occurs more broadly via the anionic field formed by ingredient C.

When the crosslinkable polymer composition is subjected to the heat molding, such as extrusion molding, the crosslinking between ingredients A and B might progress due to heat during thermal kneading prior to the forming or during a forming process. Then, the fluidity of the crosslinkable polymer composition becomes low, causing difficulties in kneading and forming. However, the crosslinkable polymer composition containing ingredient C can improve the fluidity of the crosslinked product and the crosslinkable polymer composition achieves improved heat deformability, even if the formation of the crosslinked product is in progress. As a result, the thermal kneading and the heat molding, such as extrusion molding can be carried out smoothly and effectively. Therefore, this has a significant effect on improving the production efficiency of the formed product and reducing energy consumption during forming.

Ingredient C can improve the fluidity of the crosslinked product only when ingredient C is melted into a liquid. At a temperature of the melting point of ingredient C or lower, the crosslinked product maintains low fluidity and stably retains a predetermined shape even if the crosslinked product and ingredient C coexist. In other words, the crosslinked product is transitioned reversibly between a low-temperature state in which the crosslinked product has low fluidity and low heat-moldability, and a high-temperature state in which the crosslinked product has improved fluidity and improved heat-moldability, with the melting point of ingredient C as the boundary. Thus, if the crosslinkable polymer composition is heated to a temperature of the melting point of ingredient C or higher during the heat molding, the crosslinkable polymer composition can be formed with an improved heat deformability due to the contribution of ingredient C, even if the formation of the crosslinked product is in progress between ingredients A and B. Furthermore, when the crosslinked polymer material that has been crosslinked and molded into a predetermined shape is heated to the flow starting temperature or higher of the crosslinked product and to the melting point of ingredient C or higher, ingredient C works for increasing the fluidity of the crosslinked product, whereby the crosslinked polymer material can be re-molded efficiently. On the other hand, since ingredient C does not work for improving the fluidity of the crosslinked product at a temperature of the melting point of ingredient C or lower, the crosslinked polymer material can maintain low heat deformability and high thermal stability, and ingredient C is less likely to decrease the heat resistance of the crosslinked product.

As described above, ingredient C makes the crosslinkable polymer composition and the crosslinked polymer material transition into a state having high heat deformability from a state having low heat deformability at the melting point of ingredient C. However, since the melting point of ingredient C is 190° C. or higher, ingredient C does not work for improving the heat deformability of the crosslinked polymer material unless it is heated to a temperature higher than 190° C. Therefore, in addition to the effect of the crosslinked product having the flow starting temperature of 190° C. or higher, the crosslinked polymer material maintains the low heat deformability and maintains stably a predetermined formed shape of forming at a temperature below 190° C. Thus, the crosslinked polymer material shows high heat resistance. Therefore, the crosslinked polymer material can be used suitably for applications that require heat resistance of around 190° C., such as the insulation coating of the insulated electric wire for an automobile.

The degree of improvement in heat deformability caused by ingredient C is preferably 80% or higher, and more preferably 90% or higher, in terms of the heat deformation rate of the crosslinked polymer material at a temperature of 190° C. or higher, for example at 210° C. A higher heat deformation rate at a temperature of 190° C. or higher is preferable, and no particular upper limit is specified. On the other hand, it is preferable that the heat deformation rate at a temperature below 190° C. is 20% or lower, and more preferably 10% or lower from the viewpoint of maintaining high heat resistance. A low heat deformation rate at the temperature below 190° C. is preferable, and no particular lower limit is specified. Furthermore, a ratio of the heat deformation rate at 210° C. to that at 170° C. (i.e., deformation rate at 210° C./deformation rate at 170° C.; defined as a deformation rate ratio) is preferably 5 or larger, and more preferably 10 or larger. A larger ratio of the deformation rate indicates a larger difference between the heat deformation rate between below 190° C. and that at 190° C. or higher. Furthermore, a larger ratio of deformation rate enables easy control of the state of the crosslinked polymer material around the threshold temperature of 190° C., and is highly effective in maintaining the heat resistance at a temperature below 190° C. while improving moldability at a temperature of 190° C. or higher. A larger ratio of deformation rate is preferable, and no upper limit is specified. The heat deformation rate of the crosslinked polymer material at each temperature may be evaluated by the method employed in the embodiments described later.

In the present embodiment, the crosslinked polymer material obtained by crosslinking of ingredient B may have a wide range of elastic modulus depending on the elastic modulus of the polymer material used as ingredient B, and no particular value of elastic modulus is specified. However, the crosslinked polymer material preferably has an elastic modulus of 100 MPa or lower when particularly high flexibility is required. Then, the crosslinked polymer has high flexibility. The crosslinked polymer material further preferably has an elastic modulus of 50 MPa or lower, and further preferably 20 MPa or lower. The lower limit of the elastic modulus of the crosslinked polymer material is not particularly limited but is preferably 5 MPa or more, and more preferably 10 MPa or more, from the viewpoint of ensuring sufficient mechanical strength. On the other hand, the crosslinked polymer material preferably has an elastic modulus of more than 100 MPa when particularly high mechanical strength is required. Even in this case, the elastic modulus is preferably kept below 1600 MPa from the viewpoint of ensuring the flexibility.

For the crosslinkable polymer composition according to the present embodiment, it is important for the crosslinked product to have the flow starting temperature in the specific range to obtain the crosslinked polymer material that has high heat resistance and re-moldability via crosslinking, as described above. The flow starting temperature of the crosslinked product depends on the type of the metal ion released from ingredient A, the type or structure of the polymer main chain and the side chain, and the substituent group of ingredient B, and a ratio by ingredients A and B. Furthermore, the degree of heat deformability provided by ingredient C and the temperature at which the heat deformability is enhanced are influenced by the type of ingredient C. Preferred structures and characteristics of the ingredients will be described below sequentially.

### (2) Ingredient A

Ingredient A is an ingredient from which a metal ion is released upon heating. The term “upon heating” refers to heating, and is assumed to be at a temperature equal to or higher than a room temperature. The term “the metal ion is released” means that a metal ion is released from ingredient A by decomposition or phase transition of ingredient A. The metal ion released from ingredient A causes crosslinking of ingredient B.

Ingredient A preferably has a decomposition or phase transition temperature of 50° C. or higher. Then, during preparation of the crosslinkable polymer composition or prior to use of the crosslinkable polymer composition (i.e., before crosslinking), the releasing of the metal ion from ingredient A is suppressed and the progression of crosslinking of ingredient B is suppressed. As a result, the crosslinkable polymer composition has excellent storage stability. In other words, quality deterioration of the crosslinkable polymer composition is less likely to occur due to an unintended release of the metal ion from ingredient A and the accompanying crosslinking of ingredient B, when the crosslinkable polymer composition is prepared by mixing ingredients A and B at a low temperature, such as below 50° C., or when the prepared crosslinkable polymer composition is stored. If ingredient A has the decomposition or phase transition temperature of 60° C. or higher, and even 70° C. or higher, the effect of improving storage stability is further enhanced.

Meanwhile, ingredient A preferably has the decomposition or phase transition temperature of 300° C. or lower. Then, ingredient B is less likely to cause a quality change at a temperature lower than the temperature at which the metal ion is released from ingredient A, and therefore, non-degraded ingredient B can be easily crosslinked via the metal ion. In addition, if ingredient A undergoes decomposition or phase transition at a moderate temperature, the release of the metal ion from ingredient A is facilitated, and the crosslinkable polymer composition has an excellent crosslinking speed. From these viewpoints, ingredient A preferably has the decomposition or phase transition temperature of 200° C. or lower, more preferably 150° C. or lower, and further preferably 120° C. or lower.

Further, ingredient A preferably has the decomposition or phase transition temperature equal to or higher than the flow starting temperature of ingredient B described later. Then, the crosslinking of ingredient B can progress via the metal ion released from ingredient A at the temperature at which ingredient A releases the metal ion, with ingredient B having acquired fluidity. For this reason, crosslinking can progress via the metal ion well-dispersed in ingredient B by taking advantage of the flow of ingredient B, thereby making it easier to obtain the crosslinked polymer material with a highly uniform structure in which the crosslinking points via the metal ions are spatially distributed with a high degree of uniformity. In addition, unintentional release of the metal ion from ingredient A and the resulting progress of crosslinking of ingredient B are unlikely to occur during the preparation or formation of the crosslinkable polymer composition. More preferably, ingredient A has the decomposition or phase transition temperature equal to or higher than the flow starting temperature of ingredient B, and further preferably, ingredient A has the decomposition or phase transition temperature at least 10° C. higher than the flow starting temperature of ingredient B. The decomposition or phase transition temperature of ingredient Ais expressed as a temperature at which a baseline change starts in differential scanning calorimetry (DSC) (measurement temperature range: 25° C. to 200° C., measured in air). The phase transition temperature does not include a melting point, and the phase transition mentioned above does not include melting. If ingredient A has both the phase transition temperature and the decomposition point, or has a plurality of phase transition temperatures, the lower (or the lowest) one is treated as “the decomposition or phase transition temperature”.

As described above, the effect of ingredient C which improves the heat deformability of the crosslinkable polymer composition is effectively exhibited in the crosslinkable polymer composition in a state where the crosslinked product is already formed from ingredients A and B, or in a state where the formation of the crosslinked product progresses. Here, from the viewpoint of using effectively the effect of ingredient C which improves the heat deformability, ingredient A preferably has the decomposition and phase transition temperature, which is a temperature that the crosslinking can be initiated, equal to or lower than the melting point of ingredient C, and more preferably equal to or lower than 190° C. Then, in the crosslinkable polymer composition containing ingredients A and B, high moldability can be used when the crosslinked product is subjected to the heat molding, such as extrusion molding after the crosslinked product is formed during kneading, or when the crosslinked product is formed while the heat molding is performed. By employing these methods, the crosslinked polymer material can be obtained without the need for a separate heating step for crosslinking after the crosslinkable polymer composition is already formed.

The type of metal ion released from ingredient A is not limited, but the ions of alkaline-earth, aluminum, zinc, titanium, and zirconium can be preferably used. Preferably, the metal ion released from ingredient A is at least one of these metal ions. Each metal ion is divalent or higher, and can easily form a stable crosslinked structure with the polymer chains of ingredient B by forming the ionic bond with the substituent group of ingredient B. In addition, each of alkaline-earth, aluminum, zinc, titanium, and zirconium listed above belongs to a hard acid in the HSAB principle and has a relatively high ionization tendency, which indicates that each metal is suitable for constituting the crosslinked product by forming a stable bond with the substituent group in ingredient B.

Further, when a member in contact with a metal member is composed of the crosslinkable polymer composition of the present embodiment, and if the metal contained in the crosslinkable polymer composition is the same as the main component of the metal member, an influence due to presence of the metal member tends to be minimized on the formation and stabile retention of the crosslinked structure at an interface between the metal member and the polymer material. For example, in the insulated electric wire, when the crosslinkable polymer composition according to the present embodiment is used to form the insulation coating covering the wire conductor composed of aluminum or aluminum alloy, the metal ion released from ingredient A is preferably aluminum.

While not limited to the metals listed above as preferable ones, an ion of any metal may be applied as the ion released from ingredient A as long as it crosslinks ingredient B by forming the ionic bond with the substituent group of ingredient B, and it can provide the crosslinked product having the flow starting temperature of 190° C. or higher, and more preferably 300° C. or lower. However, a transition metal, such as iron, nickel, and copper tends to allow the crosslinked product to have a flow starting temperature equal to or higher than the range mentioned above. This may be because when the crosslinked product is formed by the ion of a metal, such as the transition metal having a plurality of possible oxidation numbers or relatively low ionization tendency, each crosslinking point is less likely to move when it is heated (see FIG. 1C). In addition, the metal ion released from ingredient A may be not only a monoatomic metal ion but also a polyatomic ion (i.e., metal-containing ion) in which a metal atom and other atom are bonded. However, from the viewpoint of forming a stable ionic bond with the substituent group of ingredient B, the monoatomic metal ion is more preferable.

Ingredient A can be any chemical species as long as it releases the metal ion upon heating, but a metal complex can be used as a suitable chemical species. A metal complex is composed of a ligand with an unshared electron pair coordinately bonded to a central metal ion. The metal complex is highly effective in stabilizing the metal ion by the ligand, suppressing ingredient A from releasing the metal ion during the preparation of the crosslinkable polymer composition or prior to use of the composition. Further, when the crosslinkable polymer composition is crosslinked, the metal ion is easily released from ingredient A upon heating.

The ligand composing the metal complex may be a monodentate ligand having one coordination site or a multidentate ligand having two or more coordination sites. Due to a chelate effect, a metal complex with the multidentate ligand is more stable than a metal complex with the monodentate ligand or a metal complex with a ligand forming a bridging coordination structure, such as an alkoxide ligand. Therefore, ingredient A is preferably the metal complex with the multidentate ligand. Coordination by the multidentate ligand is more effective in stabilizing the metal ion than that by the monodentate ligand or that by a ligand forming the bridging coordination structure, whereby the releasing of the metal ion from ingredient A is more effectively suppressed during the preparation of the crosslinkable polymer composition, before using of the crosslinkable polymer composition and during forming the crosslinkable polymer composition.

Among the multidentate ligands, a bidentate β-diketonato ligand (1,3-diketonato ligand) can be suitably used. The β-diketonato ligand is particularly effective in stabilizing the metal ion. Because the metal complex including the β-diketonato ligand tends to be dispersed finely in the organic polymer, it is suitable for dispersing ingredient A in ingredient B and forming the crosslinking points with high uniformity. The β-diketonato ligand is represented by general formula (2) below:

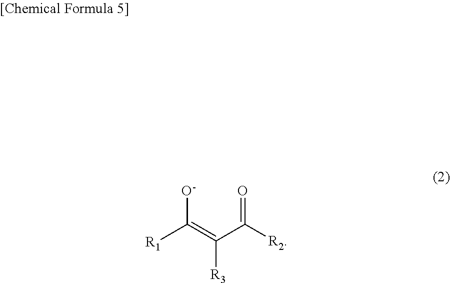

In formula (2), each of R₁ and R₂ represents independently a hydrocarbon group and R₃ represents a hydrogen atom or the hydrocarbon group, including a case where at least two among groups R₁, R₂, R₃ are interconnected by a ring structure. The ligand may take the structure of formula (2) as a resonant structure.

In formula (2), each of R₁, R₂ and R₃ may be an aliphatic hydrocarbon group or a hydrocarbon group containing an aromatic ring, or may include a hetero atom, such as an oxygen atom. As the hydrocarbon group composing each of R₁, R₂ and R₃, an alkyl group, an alkoxy group, an aromatic group, and a fused aromatic group may be included. Each number of carbon atoms of R₁, R₂ and R₃ is not particularly limited but is preferably 1 or more and 8 or less.

Examples of the β-diketonato ligand include: an acetylacetonato ligand (acac); a 2,2,6,6-tetramethyl-3,5-heptanedionato ligand (dpm); a 3-methyl-2,4-pentadionato ligand; a 3-ethyl-2,4-pentanedionato ligand; a 3,5-heptanedionato ligand; a 2,6-dimethyl-3,5-heptanedionato ligand; and a 1,3-diphenyl-1,3-propanedionato ligand. Among these, the acetylacetonato ligand in which R₁ and R₂ represent a methyl group and R₃ represents the hydrogen atom in formula (2) above is particularly preferred from the viewpoint of simplifying the structure.

The crosslinkable polymer composition preferably contains ingredient A in an amount of 0.1 part by mass or larger with respect to 100 parts by mass of the total of ingredients A, B, and C. Then, the presence of a sufficiently large amount of ingredient A relative to ingredient B allows the crosslinked product to have high crosslinking density, exhibiting a high effect of improving the heat resistance. From the viewpoint of enhancing the effect of improving the heat resistance, the amount of ingredient A is more preferably 1.0 part by mass or larger, and further preferably 2.0 parts by mass with respect to the 100 parts by mass. On the other hand, the amount of ingredient A is preferably 30 parts by mass or smaller with respect to the 100 parts by mass. If the amount of ingredient A is 30 parts by mass or smaller, with respect to the 100 parts by mass, it is likely to avoid an influence caused by the presence of a large amount of ingredient A, including separation or precipitation of ingredient A before crosslinking, and embrittlement and reduction of flexibility of the polymer material after crosslinking. Furthermore, the absence of an excessive amount of ingredient A in the crosslinkable polymer composition allows high mechanical strength of ingredient B to be exhibited effectively as an overall characteristic of the crosslinked polymer material. From the viewpoint of enhancing these effects, the amount of ingredient A is preferably 20 parts by mass or smaller, and more preferably 10 parts by mass or smaller with respect to the 100 parts by mass.

### (3) Ingredient B

Ingredient B is composed of an organic polymer having a side chain, and the side chain includes an electron-withdrawing substituent group capable of forming an ionic bond with a metal ion released from ingredient A. The substituent group is not necessarily required to be the electron-withdrawing to form an ionic bond with the metal ion released from ingredient A; however, the electron-withdrawing substituent group can form a stable ionic bond with the metal ion. Therefore, when ingredient B is crosslinked by the metal ion in the crosslinkable polymer composition, the crosslinked structure is formed stably, and the crosslinked product tends to exhibit high heat resistance.

Preferable examples of the electron-withdrawing substituent groups capable of forming the ionic bond with the metal ion include acidic groups, such as a carboxylic acid group, an acid anhydride group, a phosphoric acid group, and an acrylic acid group, other than a hydroxyl group. The substituent group may be only one or at least two, but the substituent group is preferably at least one of the above-listed substituent groups. Especially, a maleic acid group and an acrylic acid group can be suitably employed. An acid anhydride group, such as a maleic anhydride group can also be suitably employed. The substituent groups listed above are excellent in readily forming the ionic bond with the metal ion released from ingredient A. Further, since each of the above-listed substituent groups is an acidic group with relatively low polarity, phase separation is less likely to occur to the main and side chains of ingredient B, and the crosslinked structure can be formed in the matrix of ingredient B with high uniformity. Although a sulfonic acid group, for example, is also an electron-withdrawing substituent group that is likely to form an ionic bond with the metal ion, it is less suitable than those listed above for the substituent group of ingredient B because phase separation is likely to occur due to high polarity.

In ingredient B, as described above, the substituent group forming the ionic bond with the metal ion is included not in the polymer main chain but in the side chain. Therefore, the crosslinking site maintains a high degree of freedom of movement when the crosslinked structure is formed. As a result, the crosslinked polymer material obtains high re-moldability. Furthermore, since the electron-withdrawing group is included in the side chain, it is possible to obtain an enhanced effect of improving the fluidity of the crosslinked product due to the contribution of the anionic field formed by ingredient C. From the viewpoint of enhancing these effects, the substituent group is preferably bonded to the main chain via the alkyl or the alkylene group having 1 or more carbon atoms, although the structure and length of the side chain are not particularly limited. Alternatively, the side chain may be the one which bonds the substituent group to the main chain via a hetero atom, such as an oxygen atom. The substituent group may be introduced to an end of the side chain or in the middle thereof, but preferably introduced to the end from the viewpoint of increasing effectively the degree of freedom of movement at the crosslinking site. Although no particular upper limit is specified in the number of the carbon atoms in the side chain, the number of the carbon atoms connecting the main chain and the substituent group is preferably 4 or less from the viewpoint of minimizing the influence on the physical properties of the main chain. When the substituent group is the carboxylic acid group or the phosphoric acid group, particularly preferred structures of the side chain portions are represented by formulae (3) and (4) below, respectively:

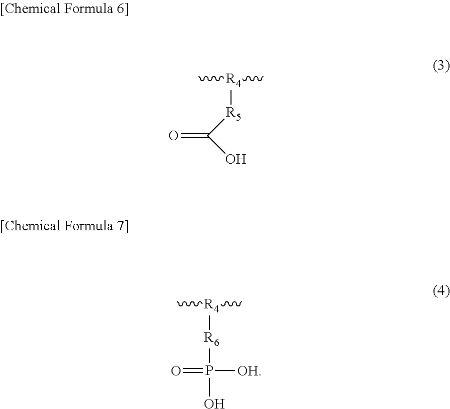

Here, R₄ represents a main chain, R₅ represents an oxygen atom, or an alkyl or alkylene group having one or more carbon atoms, and R₆ represents an alkyl or alkylene group having one or more carbon atoms. A plurality of electron-withdrawing substituent groups may be bonded to the main chain via a common R₅ or R₆. In addition, the plurality of electron-withdrawing substituent groups may form an anhydride with each other.

In ingredient B, the electron-withdrawing substituent group may be or may not be included in the main chain, as long as being included in the side chain. However, the electron-withdrawing substituent group is preferably not included in the main chain. This is because the presence of the electron-withdrawing group in the main chain may prevent the electron-withdrawing group in the side chain from forming the crosslinked structure through the ionic bond with the metal ion. The electron-withdrawing group in the main chain tends to be subjected to significant steric hindrance and less likely to contribute effectively to the crosslinking by the formation of the ionic bond with the metal ion, resulting in exhibiting poor effect in improving heat resistance through crosslinking. Further, even when the crosslinked structure is formed at a portion of the electron-withdrawing group in the main chain, the degree of freedom of movement remains low at the crosslinking site, thereby making it difficult to achieve high re-moldability. Furthermore, it is difficult to obtain the effect of ingredient C which improves fluidity. Examples of the electron-withdrawing groups that are preferably not contained in the main chain in ingredient B include a carboxy group having the main chain composed of a copolymer of (meth) acrylic acid, and halogen atoms.

Although not particularly limited, the amount of the substituent group included in the side chain of ingredient B is preferably 0.01% by mass or larger and 10% by mass or smaller with respect to the total mass of ingredient B from the viewpoint of ensuring physical properties by crosslinking. The amount is more preferably 0.1% by mass or larger and 5% by mass or smaller and further preferably 0.2% by mass or larger and 3% by mass or smaller. The amount of the substituent group in ingredient B can be determined by comparison of the intensity of a peak specific to the substituent group in the infrared spectrum with the intensity of the spectrum peak of a material containing a known amount of the substituent group.

The organic polymer composing ingredient B is a polymerized organic material, such as a resin, a rubber, and an elastomer. Ingredient B is preferably composed of a resin having thermoplasticity, from the viewpoint of the moldability when the heat molding, such as extrusion molding is performed. Particularly, from the viewpoint of obtaining high moldability and flexibility, the main chain in ingredient B is preferably formed of an elastomer. Examples of the elastomer include a styrene-based thermoplastic elastomer, such as a styrene-ethylene-butylene-styrene block copolymer (SEBS), and an olefin-based elastomer, such as an ethylene-α-olefin copolymer. The main chains composed of the styrene-based thermoplastic elastomer or the olefin-based elastomer are highly flexible and less likely to influence the formation of each crosslinking point in the side chain, the activation of the molecular motion and the movement of each crosslinking point at the crosslinking site caused by heating, and delocalization of each crosslinking point caused by ingredient C. Therefore, high heat resistance and re-moldability brought about by these phenomena in the side chain are effectively exhibited as the properties of the crosslinked product as a whole of ingredient B. Examples of the organic polymer capable of composing the main chain in ingredient B other than the elastomers include polyolefins, such as polyethylene and polypropylene, and ethylene copolymers, such as ethylene-methyl acrylate copolymer (EMA) and ethylene-vinyl acetate copolymer (EVA).

Ingredient B preferably has a flow starting temperature of 50° C. or higher and 190° C. or lower. Then, the crosslinked product having the flow starting temperature of 190° C. or higher and preferably 300° C. or lower can be provided easily through crosslinking via the metal ion released from ingredient A. In addition, high moldability is obtained by utilizing the fluidity of ingredient B (including the case where ingredient B is already crosslinked by the metal ion derived from ingredient A), when the crosslinkable polymer composition is molded by heating to a temperature equal to or higher than the melting point of ingredient C, which is 190° C. or higher. The flow starting temperature of ingredient B is more preferably 80° C. or higher and 160° C. or lower.

From the viewpoint of increasing flexibility of the crosslinked polymer material, ingredient B preferably has a Shore D hardness of 60 or lower, more preferably 50 or lower, and further preferably 40 or lower. Meanwhile, from the viewpoint of ensuring the mechanical strength of the crosslinked polymer material, ingredient B preferably has the Shore D hardness of 10 or higher. The Shore D hardness of ingredient B can be measured in accordance with JIS K 6253. When it is desired to obtain the polymer material after crosslinking that has particularly enhanced mechanical strength, a polymer is preferably used as ingredient B, having a relatively high Shore D hardness, such as higher than 40, but not exceeding 60 or lower, or even having the Shore D hardness exceeding 60. Meanwhile, even in this case, ingredient B preferably keeps the Shore D hardness of 70 or lower, from the viewpoint of ensuring the flexibility of the crosslinked polymer material.

### (4) Ingredient C

Ingredient C is composed of a compound having a structure represented by formula (1) indicated again below and having a melting point of 190° C. or higher:

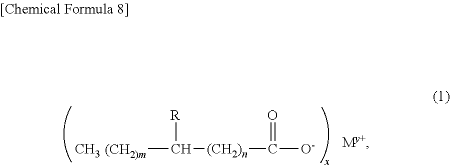

where R represents a hydrogen atom or a hydroxyl group. Each of m and n independently represents an integer of 1 or more, and m+n is 11 or more and 30 or less. M^{y+} represents a y-valent metal ion, where y is an integer of 1 or more and x=y.

As represented in formula (1), ingredient C is composed of a long-chain organic acid and a metal, and forms the broad anionic field over a wide range through polarization between the organic acid moiety and the metal moiety. Furthermore, ingredient C delocalizes the crosslinked structure of the crosslinked product formed by ingredient B and the metal derived from ingredient A, and works for improving fluidity of the crosslinked product. Ingredient C in a liquid state functions as a kind of plasticizer. This phenomenon occurs only when ingredient C is in a liquid state, i.e., at a temperature of 190° C. or higher because the melting point of ingredient C is 190° C. or higher. At a temperature lower than 190° C., the fluidity of the crosslinked product is not improved even when ingredient C coexists, and the crosslinked polymer material maintains high heat resistance. If ingredient C has a melting point lower than 190° C., ingredient C is melted at a temperature lower than 190° C., ingredient C in a liquid state functions as a solvent. Furthermore, the formation of the anionic field as described above causes delocalization of the crosslinked structure of the crosslinked product. As a result, the crosslinked product becomes highly fluid, resulting in a reduction in heat resistance of the crosslinked polymer material. From the viewpoint of improving the heat resistance of the crosslinked polymer material, the melting point of ingredient C is more preferably 200° C. or higher and further preferably 210° C. or higher.

The upper limit of the melting point of ingredient C is not particularly limited but is preferably 300° C. or lower. Then, ingredient C works to improve fluidity of the crosslinked product, without the need for heating of the crosslinked product to an excessively high temperature. The melting point of ingredient C is more preferably 280° C. or lower. Furthermore, it is preferable that the melting point of ingredient C is equal to or higher than the flow starting temperature of the crosslinked product formed from ingredients A and B, and is equal to or higher than the decomposition or phase transition temperature of ingredient A.

The melting point of ingredient C is determined by a three-dimensional structure of the molecule, varies depending on crystallinity of ingredient C. The melting point of ingredient C takes a unique value depending on a combination of the structure of the organic chain and a metal species. In formula (1), if m+n is 11 or more, ingredient C has a sufficiently high melting point. Furthermore, since m+n takes a large value, such as 11 or more, ingredient C exhibits high compatibility to ingredient B or the crosslinked product formed from ingredients B and A. It is preferable that m+n is 13 or more. Meanwhile, when m+n is 30 or less, it is possible to suppress the melting point of ingredient C from being excessively high. It is preferable that m+n is 23 or less, and more preferably 17 or less. Furthermore, the organic acid moiety has a linear structure. Since the organic acid moiety has a linear structure, the organic acid moiety has high crystallinity and ingredient C is likely to have high melting point. It is preferable that R in formula (1) is the hydrogen atom and the organic acid moiety is a fatty acid. Meanwhile, even if R is a hydroxyl group, the hydroxyl group does not interact with the carboxyl group or the metal of ingredient C, nor the crosslinked product formed from ingredients A and B. Therefore, the behavior of ingredient C in the crosslinkable polymer composition and the crosslinked polymer material does not differ significantly, compared with the case in which R is the hydrogen atom.

Suitable examples of organic acids that compose ingredient C include the following:
Stearic acid (m+n=15, R═H)
12-hydroxystearic acid (m=5, n=10, R═OH)
Behenic acid (m+n=19, R═H)
Montanic acid (m+n=25, R═H)
Margaric acid (m+n=14, R═H)
Palmitic acid (m+n=13, R═H)

The valence of metal M composing ingredient C is not limited, but the metal M is preferably monovalent. When the metal M is monovalent, ingredient C has a simpler molecular structure than when the metal M is divalent or more, and forms a stronger crystalline structure, thereby providing a high melting point to ingredient C. Furthermore, even if ingredient C is partially decomposed at a high temperature and releases a metal ion, and the metal ion interacts (i.e., bonds ionically) with ingredient B, the monovalent metal ion is less likely to form a crosslinked structure, and less likely to influence the formation of the crosslinked product by the metal derived from ingredient A and the fluidity of the crosslinked product. Preferable examples of the monovalent metal composing ingredient C include alkali metals, such as Li and Na. When the divalent metal is used, alkaline earth metals including Ba can be used.

It may seem to be possible to use the organic acid itself, that is, a molecule in which the metal M in formula (1) is replaced by the hydrogen atom (H), or a molecule having an electron-donating organic functional group, such as an amide group, instead of the metal M, as ingredient C. However, these molecules do not form an anionic field effective for improving the fluidity of the crosslinked product even when they are heated at a high temperature. Therefore, these molecules can not be used as ingredient C.

The crosslinkable polymer composition preferably contains ingredient C in an amount of 1.0 part by mass or larger with respect to 100 parts by mass of the total of ingredients A, B, and C. Then, it is possible to obtain the significant effect of improving fluidity of the crosslinked product formed from ingredients A and B, via the formation of the anionic field by ingredient C. More preferably, the crosslinkable polymer composition contains ingredient C in an amount of 3.0 parts by mass or larger, and still more preferably 5.0 parts by mass or larger with respect to 100 parts by mass of the total of ingredients A, B, and C. On the other hand, the crosslinkable polymer composition preferably contains ingredient C in an amount of 30 parts by mass or smaller with respect to 100 parts by mass of the total of ingredients A, B, and C. Then, the formation of aggregates by ingredient C can be avoided. Furthermore, ingredient B can be contained in a relatively high content, and physical properties exhibited by ingredient B, having the mechanical strength and the low-temperature characteristics, can sufficiently appear in the crosslinkable polymer composition. The crosslinkable polymer composition further preferably contains ingredient C in an amount of 20 parts by mass or smaller, or 10 parts by mass or smaller with respect to 100 parts by mass of the total of ingredients A, B and C.

### (5) Other Ingredients

The crosslinkable polymer composition according to the present embodiment may contain additives, such as a flame retardant, a copper damage inhibitor, an antioxidant, and a colorant as appropriate, in addition to the above-described ingredients A, B, and C, as long as these additives do not impair a function of the material. Examples of other additives include a secondary or tertiary amine represented by formula (5) below. The amine, when it is added to the crosslinkable polymer composition, suppresses the rate of crosslinking of ingredient B from progressing by ingredient A, and the crosslinking progresses highly uniformly in the whole material. As a result, the degree of crosslinking is improved, and high wear resistance is obtained in the crosslinkable polymer composition. Example of the amount of the amine to be added to the crosslinkable polymer composition is 0.5 parts by mass or larger and 20 parts by mass or smaller with respect to 100 parts by mass of the total of ingredients A and B.

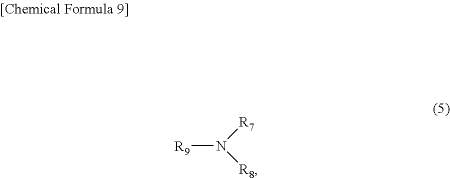

where R₇ represents a hydrogen atom or a hydrocarbon group having 30 or fewer carbons; R₉ represents a hydrocarbon group having 30 or fewer carbons; and R₉ represents a hydrocarbon group having 13 to 30 carbons.

Furthermore, although an organic polymer other than ingredient B may be contained as a polymer component in the crosslinkable polymer composition according to the present embodiment, the amount of the polymer component is preferably smaller than ingredient B. More preferably, the crosslinkable polymer composition contains only ingredient B as the polymer component. Compounds of the following groups (a) to (f) are preferably not added in the crosslinkable polymer composition as the ingredient. Examples of the ingredients preferably not added in the crosslinkable polymer composition include: (a) silane coupling agents, (b) epoxy compounds, (c) isocyanate and isothiocyanate compounds, (d) photo-radical and thermal-radical generators, (e) chlorine and bromine compounds, and (f) volatile organic solvents If the compounds of the groups (a) to (d) are contained in the crosslinkable polymer composition, unintended chemical reactions may occur, such as crosslinking of ingredient B due to a reaction other than the crosslinking reaction via the metal ion released from ingredient A when heated, or cleavage of the main chain in ingredient B. Then, heat resistance and re-moldability of the crosslinkable polymer composition may not be sufficiently exhibited. Further, if the compounds of group (e) are contained in the crosslinkable polymer composition, coloration or generation of corrosive gases may occur upon heating. If the compounds of group (f) are contained in the crosslinkable polymer composition, ignition or generation of bubbles may occur during the formation of a composition.

The crosslinkable polymer composition can be prepared by mixing ingredients A, B, and C, and additives added as needed. The mixing of each ingredient can be done by the thermal kneading. Thereafter, the thus obtained crosslinkable polymer composition may be molded into any shape, by heat molding, such as extrusion molding. When the thermal kneading and heat molding are performed at a temperature equal to or higher than the decomposition or phase transition temperature of ingredient A, and equal to or higher than the melting point of ingredient C or higher, the crosslinkable polymer composition can be molded into a predetermined shape in a highly fluid state, in the state where formation of the crosslinked product has already been completed or is in progress from ingredients A and B. In this case, it is not necessary to perform heating for crosslinking after forming. Furthermore, the temperature during thermal kneading and heat molding is preferably set to the flow starting temperature or higher of the crosslinked product formed from ingredients A and B. Furthermore, by heating the once-formed crosslinked polymer material into a predetermined shape to the flow starting temperature of the crosslinked product or higher, and the melting point of ingredient C or higher, the crosslinked polymer material obtains fluidity and becomes re-moldable. Re-molding can be repeated reversibly. Since the crosslinkable polymer composition according to the present embodiment can form the crosslinked structure only by heating without requiring any other operation, the crosslinking process can be carried out with simpler facilities than when the electron-beam crosslinking or the silane crosslinking is employed. The re-molding process can also be carried out by applying an appropriate external force while heating, similarly with simple facilities.

### [2] Insulated Electric Wire and Wiring Harness

The crosslinked polymer material composed of the crosslinkable polymer composition according to the present embodiment can be applied for constituting any component. However, by taking advantage of high heat resistance and moldability, the crosslinked polymer material is suitable for use as a material for constituting the insulated electric wire and the wiring harness for an automobile. In the insulated electric wire and the wiring harness, heat is easily generated by application of the electrical current to the metal member, such as the wire conductor, and therefore, the polymer material located near the metal member is also required to have high heat resistance so that it is unlikely to undergo irreversible deformation when heat is generated. Meanwhile, the crosslinkable polymer composition is required to have high fluidity with superior moldability when it is molded into a desired shape by heat molding, such as extrusion molding. In addition, in some cases, the re-molding of the polymer material once molded into a predetermined shape may be required, based on a request for the deformation of the insulated electric wire or change in the configuration of the wiring harness.

In the insulated electric wire and the wiring harness, the crosslinked polymer material according to the present embodiment can be applied to the insulation coating that covers the outer periphery of the wire conductor of the insulated electric wire, an exterior material which binds a plurality of insulated electric wires in the wiring harness, a wire protection material, or a water-stopping plug to seal the connector, although applicable locations are not specifically limited. Among these, the insulation coating of the insulated electric wire is preferably composed of the crosslinked polymer material according to the present embodiment.

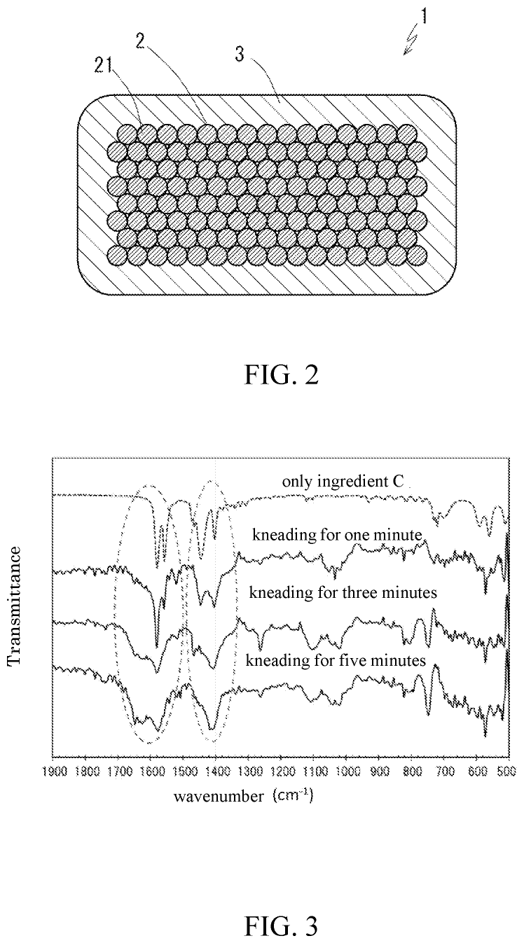

FIG. 2 illustrates an example of the insulated electric wire according to an embodiment of the present disclosure in a cross section perpendicular to an axial direction. An insulated electric wire 1 illustrated in FIG. 2 has a wire conductor 2 and an insulation coating 3 covering an outer periphery of the wire conductor 2. The wire conductor 2, although not particularly limited in configuration, is configured as a twisted conductor in which a plurality of elemental wires 21 are twisted together. In addition, in the illustrated example, the insulated electric wire 1 has a flat portion, and the cross-section of the wire conductor 2 has a flat shape (i.e., a shape elongated in the width direction). The insulation coating 3 is composed of the crosslinked polymer material according to the embodiment of the present disclosure described above. The insulation coating 3 also has a flat cross-sectional outer shape, following the shape of the wire conductor 2.

In the insulated electric wire 1, heat is generated upon application of electrical current to the wire conductor 2, and the insulation coating 3 is also heated. However, the insulation coating 3 is composed of the crosslinked polymer material according to the present embodiment described above and has high heat resistance. Therefore, even if the insulation coating 3 is heated below 190° C., for example, it is unlikely to cause thermal influences, such as irreversible deformation.

Due to having the flat portion, the insulated electric wire 1 can improve a space-saving property by reducing a space required for routing. Here, by taking advantage of the re-moldability of the crosslinked polymer material constituting the insulation coating 3, the insulated electric wire 1 having the flat portion can be readily formed using a conventional insulated electric wire having a circular cross section (i.e., a round electric wire). For example, if the crosslinkable polymer composition according to an embodiment of the present disclosure is thermally kneaded and extruded onto an outer circumference of the wire conductor 2, the round electric wire can be manufactured. In this process, when the extrusion molding is performed at the decomposition or phase transition temperature of ingredient A or higher, and the melting point of ingredient C or higher, the extrusion molding can be performed smoothly in the state where the crosslinkable polymer composition having high heat deformability, and the insulated electric wire can be obtained in the state where the crosslinked product of ingredients A and B is formed through the extrusion molding. If the insulated electric wire is used without a flat portion, the round electric wire as prepared can be used.

When the insulated electric wire is provided with the flat portion, the flat portion can be readily formed by applying a compression force in one direction to the round electric wire, while being heated at a temperature equal to or higher than the flow starting temperature of the crosslinked product and equal to or higher than the melting point of ingredient C. This is because the wire conductor 2 is in the form of the twisted conductor, which is easily deformed by applying force, and the insulation coating 3 is in a fluid state by heating, which can be easily deformed in accordance with the deformation of the wire conductor 2. Thereafter, the crosslinked product can be returned to the original stable state by cooling the insulation coating 3. Alternatively, the already-formed flat portion can be returned to a shape of the round electric wire or a lower-flatness shape close to the shape of the round electric wire by applying force from both sides in the width direction to compress the insulation coating 3, while heating the insulation coating 3 at a temperature equal to or higher than the flow starting temperature of the crosslinked product and equal to or higher than the melting point of ingredient C. Again in this case, the insulation coating 3 is deformed into a lower-flatness shape in accordance with the deformation of the wire conductor 2.

Because the insulation coating 3 is made of the crosslinkable polymer composition containing ingredient C in addition to ingredients A and B, as described above, it is possible to form the insulation coating 3 onto the outer circumference of the wire conductor 2 by extrusion molding, in the state where the crosslinkable polymer composition has high heat deformability. Furthermore, because the insulation coating 3 is made of a material having reversible re-moldability, the insulated electric wire 1 can be deformed easily, while deforming the insulation coating 3 in accordance with the wire conductor 2, into any shape in both directions between the flat cross-sectional shape and a circular cross-sectional shape, for example. For example, a cross-sectional shape of the insulated electric wire can be changed with a high degree of freedom, by forming the flat portion on the round electric wire only at a portion where a space-saving property is required in a routing path. Then, it is possible to produce a variety of insulated electric wires having flat portions at different locations, by using a common electric wire as a raw material, for example. The insulated electric wire can be used alone or in the form of a wiring harness, including the insulated electric wire, by connecting a member, such as a connection terminal or binding the insulated electric wire with another insulated electric wire.

### Example

Examples are now described. The present disclosure is not limited to the examples. Unless otherwise specified, samples were prepared and evaluated at room temperature in air.

### <Sample Preparation>

To prepare samples A1 to A22 and B1 to B20 respectively, ingredients A, B, and C were mixed with compositions mentioned in Tables 1 and 2 (unit: parts by mass. Mixing was performed at 240° C. at 50 rpm for five minutes, using a kneading and extrusion testing machine “Labo Plastomill”, manufactured by TOYO SEIKI Co., Ltd. Thereafter, each mixture was press-formed for five minutes to prepare a 2 mm-thick sample sheet. For each evaluation, the sample sheet was used after being left for more than 24 hours after heating and pressing. By heating to 240° C. during kneading and press-forming, crosslinking of ingredient B occurred via a metal ion derived from ingredient A at least in each of samples A1 to A22. The progress of crosslinking was confirmed by infrared absorption spectroscopy. More specifically, absorptions corresponding to the C═O stretching vibration of acid anhydride (around 1790 cm⁻¹) and a C═O stretching vibration of carboxylic acid (around 1720 cm⁻¹), present in the infrared absorption spectrum of ingredient B before crosslinking, were confirmed to disappeared or decreased due to crosslinking in each sample.

The following materials were used:

### (1) Ingredient A

Material types and their decomposition or phase transition temperatures obtained from DSC measurement are shown below. The decomposition or phase transition temperatures are shown in parentheses, along with a material type:
Ca-AA: Calcium (II) acetylacetonate (110° C.)
Zn-AA: Zinc (II) acetylacetonate (105° C.)
Al-AA: Aluminum (III) acetylacetonate (112° C.)
Zr-AA: Zirconium (IV) acetylacetonate (180° C.)
ZnO: Zinc oxide (II) (None (>300° C.))
stCa: Calcium stearate (93° C.)

### (2) Ingredient B

Material types and their flow starting temperatures (measured by the same method as that described in the section of Evaluation Methods below) and hardness (Shore D hardness measured in accordance with JIS K 6253) are shown below:
MAH-SEBS: Maleic acid modified hydrogenated styrene thermoplastic elastomer; “M1911”; manufactured by Asahi Kasei; flow-starting temperature: 142° C., Shore D hardness: 36
MAH-EO: Maleic acid modified ethylene-alpha olefin copolymer; “MH5020”; manufactured by Mitsui Chemicals; flow starting temperature: 132° C., Shore D hardness: 15
MAH-EVA: Maleic acid modified ethylene-vinyl acetate copolymer; “OREVAC 18211”; manufactured by SK Functional Polymer; flow starting temperature: 42° C.; Shore D hardness: 10
MAH-LLDPE: Maleic acid modified low density polyethylene; “OREVAC 18302N”; manufactured by SK Functional Polymer; flow starting temperature: 95° C.; Shore D hardness: 18
MAH-PP: Maleic acid modified polypropylene, “Admer QB550”; manufactured by Mitsui Chemicals; flow starting temperature: 142° C.; Shore D hardness 58
AA-PP: Acrylic acid modified polypropylene; “Polybond 1001”; manufactured by Chemtura; flow starting temperature: 139° C.; Shore D hardness: 45
EMAA: Ethylene-methacrylic acid copolymer; “N1110H”; manufactured by Dow-Mitsui Polychemicals; flow starting temperature: 109° C.; Shore D hardness: 49
SEBS: Hydrogenated styrene-based thermoplastic elastomer; “H1041”; manufactured by Asahi Kasei; flow starting temperature: 137° C.; Shore D hardness: 36.

### (3) Ingredient C

Material types of ingredient C are shown below. The melting point of each material is as shown in Tables 1 and 2. “stA”, “ERA”, and “EBSA” were manufactured by Tokyo Chemical Industry Co., Ltd., and the other materials were manufactured by Nitto Chemical Industry Co., Ltd.
stNa: Sodium stearate
stLi: Lithium stearate
stBa: Barium stearate
HstNa: Sodium 12-hydroxystearate
HstLi: Lithium 12-hydroxystearate
BeNa: Sodium behenate
BeLi: Lithium behenate
MoNa: Sodium montanate
MoLi: Lithium montanate
stCa: Calcium stearate
stZn: Zinc stearate
HstCa: Calcium 12-hydroxystearate
MoCa: Calcium montanate
LaLi: Lithium laurate
stA: Stearic acid
ERA: Erucamide
EBSA: Ethylenebis(stearylamide)

### <Evaluation Methods>

### (1) Flow Starting Temperature

A 10 mm×10 mm×2 mm thick test piece was prepared using each of the sample sheets. The test piece was placed on a hot plate with a variable temperature, and a 2 mmφ cylindrical indenter with a dial gauge attached to the top was pressed against the center of the test specimen with a force of 1N. Then, a distance in which the indenter penetrated into the sample was recorded, while the temperature of the hot plate was increased at a rate of 5° C./min.

The flow starting temperature was defined as the temperature at which the indenter penetration reached 2.0 mm (i.e., the indenter penetrated through the sample sheet). If the flow starting temperature of a sample was at least 5° C. higher than that of ingredient B that did not contain ingredient A and ingredient C, the sample was regarded as having improved heat resistance through crosslinking via the metal ion.

### (2) Elastic Modulus

Each of the sample sheets was cut into a strip of 50 mm long×5 mm wide×2 mm thick. A tensile test was conducted at room temperature in air at a speed of 10 mm/min. with a grip width of 10 mm. An elastic modulus (i.e., elastic modulus) was obtained by converting deformation between 1N and 2N of tensile load.

### (3) Heat Deformation

A 10 mm×10 mm×2 mm thick test piece was prepared using each of the sample sheets. The test piece was fixed to the side surface of a stainless steel round bar with a diameter of 10 mm to prepare a test specimen, and the surface of the test specimen was pressed with a metal blade having a thickness of 0.7 mm. During this operation, the load F(N) with which the blade was pressed was set based on the following formula:

$$F = {0.7 [ i ( 2 D - i ) ]}^{1 / 2} ,$$

where “i” represents the thickness of the sample sheet, which was 2 (mm). “D” represents the outer diameter of the test specimen, which was 14 (mm) calculated as 10 (mm)+2i. The load according to the formula mentioned above was determined by referring to the setting method used in JIS C 3660-508.

The test specimen on which the blade was pressed as mentioned above was heated in an oven at 170° C. or 210° C. for four hours. Then, after the blade was removed, the test specimen was cooled to room temperature. Thereafter, the depth of a resulting indentation was measured with a laser microscope. The ratio of the depth of the cavity relative to the thickness (i.e., 2 mm) of the sample piece used was defined as the deformation rate (%). The deformation rate at 170° C. was defined as the “170° C. deformation rate” and the deformation rate at 210° C. was defined as the “210° C. deformation rate”. The 210° C. deformation rate relative to the 170° C. deformation rate was defined as a “deformation rate ratio” (210° C. deformation rate/170° C. deformation rate). The larger the deformation rate ratio, the greater the difference in heat deformation between below 190° C. and that at 190° C. or higher, indicating that the material was more effective in maintaining the heat resistance below 190° C. and improving forming efficiency at 190° C. or higher. If the deformation rate ratio was 5 or more, those effects can be regarded as sufficient.

### (4) Appearance of Sample Sheet

A surface of each of the sample sheets mentioned above was visually observed and evaluated in appearance. The sample sheet having a smooth and uniform surface was evaluated as “excellent in appearance” (i.e., “A+”), and the sample sheet having smooth surface while having minute color irregularities was evaluated as “good in appearance” (i.e., “A”). Meanwhile, in terms of color and smoothness, the sample sheet having an uneven surface with obvious aggregates or incompatibilities was evaluated as “poor in appearance” (i.e., “B”)).

(5) Change in State of Composition with Kneading

The contribution of ingredient C was examined from a change in the crosslinkable polymer composition with kneading, using infrared absorption spectroscopy. Here, a composition containing 5 parts by mass of Ca-AA as ingredient A, 95 parts by mass of MAH-SEBS as ingredient B, and 5 parts by mass of stLi as ingredient C was prepared. The composition was kneaded at 240° C. for one minute, three minutes, and five minutes, respectively, to prepare measurement samples. An infrared absorption spectrum was measured in each measurement sample. In addition, a reference sample was prepared containing 5 parts by mass of Ca-AA as ingredient A, and 95 parts by mass of MAH-SEBS as ingredient B, without ingredient C, and the infrared absorption spectrum of the reference sample was measured. A differential spectrum of each measurement sample was obtained by subtracting the spectrum of the reference sample from the spectrum of each measurement sample. The differential spectrum corresponds to the extracted contribution of ingredient C in each measurement sample.

### <Result of Evaluation>

Tables 1 and 2 below show the content of each ingredient (unit: parts by mass) for samples A1 to A22 and B1 to B20 in the upper rows, and the results of the evaluation in the lower rows.

TABLE 1

| | | Melting | | | | | | | | | | | |
|---|---|---|---|---|---|---|---|---|---|---|---|---|---|
| | | Point | | | | | | | | | | | |
| | | (° C.) | A1 | A2 | A3 | A4 | A5 | A6 | A7 | A8 | A9 | A10 | A11 |
| Ingredient | Ca-AA | — | 5.0 | | | | 5.0 | 5.0 | 5.0 | 5.0 | 5.0 | 5.0 | 5.0 |
| A | Zn-AA | — | | 5.0 | | | | | | | | | |
| | Al-AA | — | | | 5.0 | | | | | | | | |
| | Zr-AA | — | | | | 5.0 | | | | | | | |
| | ZnO | — | | | | | | | | | | | |
| | stCa | — | | | | | | | | | | | |
| Ingredient | MAH-SEBS | — | 90.0 | 90.0 | 90.0 | 90.0 | | | | | | | 90.0 |
| B | MAH-EO | — | | | | | 90.0 | | | | | | |
| | MAH-EMA | — | | | | | | 90.0 | | | | | |
| | MAH-EVA | — | | | | | | | 90.0 | | | | |
| | MAH-LLDPE | — | | | | | | | | 90.0 | | | |
| | MAH-PP | — | | | | | | | | | 90.0 | | |
| | AA-PP | — | | | | | | | | | | 90.0 | |
| | EMAA | — | | | | | | | | | | | |
| | SEBS | — | | | | | | | | | | | |
| Ingredient | stNa | 270 | 5.0 | 5.0 | 5.0 | 5.0 | 5.0 | 5.0 | 5.0 | 5.0 | 5.0 | 5.0 | |
| C | stLi | 220 | | | | | | | | | | | 5.0 |
| | stBa | >225 | | | | | | | | | | | |
| | HstNa | 215 | | | | | | | | | | | |
| | HstLi | 220 | | | | | | | | | | | |
| | BeNa | >225 | | | | | | | | | | | |
| | BeLi | 215 | | | | | | | | | | | |
| | MoNa | 210 | | | | | | | | | | | |
| | MoLi | 205 | | | | | | | | | | | |
| | stCa | 148 | | | | | | | | | | | |
| | stZn | 125 | | | | | | | | | | | |
| | HstCa | 150 | | | | | | | | | | | |
| | MoCa | 135 | | | | | | | | | | | |
| | LaLi | >225 | | | | | | | | | | | |
| | stA | 70 | | | | | | | | | | | |
| | ERA | 83 | | | | | | | | | | | |
| | EBSA | 144 | | | | | | | | | | | |
| Flow-Starting | | | 231 | 228 | 225 | 221 | 228 | 205 | 197 | 220 | 223 | 212 | 217 |
| Temperature(° C.) | | | | | | | | | | | | | |
| Elastic Modulus (MPa) | | | 13.5 | 12.1 | 14.8 | 13.1 | 2.9 | 21.4 | 2.1 | 13.0 | 890 | 680 | 13.8 |
| 170° C. Deformation Rate(%) | | | 8.0 | 8.1 | 8.1 | 8.2 | 9.3 | 8.0 | 9.7 | 8.3 | 2.1 | 3.5 | 8.2 |
| 210° C. Deformation Rate(%) | | | 92.5 | 92.4 | 92.7 | 93.4 | 93.2 | 91.8 | 98.4 | 94.0 | 98.9 | 94.5 | 96.8 |
| Deformation Rate Ratio | | | 11.6 | 11.4 | 11.4 | 11.4 | 10.0 | 11.5 | 10.1 | 11.3 | 47.1 | 27.0 | 11.8 |
| (210° C./170° C.) | | | | | | | | | | | | | |
| Appearance of Sheet | | | A+ | A+ | A+ | A+ | A+ | A+ | A+ | A+ | A+ | A+ | A+ |
| | | Melting | | | | | | | | | | | |
| | | Point | | | | | | | | | | | |
| | | (° C.) | A12 | A13 | A14 | A15 | A16 | A17 | A18 | A19 | A20 | A21 | A22 |
| Ingredient | Ca-AA | — | 5.0 | 5.0 | 5.0 | 5.0 | 5.0 | 5.0 | 5.0 | 5.0 | 5.0 | 5.0 | 5.0 |
| A | Zn-AA | — | | | | | | | | | | | |
| | Al-AA | — | | | | | | | | | | | |
| | Zr-AA | — | | | | | | | | | | | |
| | ZnO | — | | | | | | | | | | | |
| | stCa | — | | | | | | | | | | | |
| Ingredient | MAH-SEBS | — | 90.0 | 90.0 | 90.0 | 90.0 | 90.0 | 90.0 | 90.0 | 94.0 | 70.0 | 94.0 | 70.0 |
| B | MAH-EO | — | | | | | | | | | | | |
| | MAH-EMA | — | | | | | | | | | | | |
| | MAH-EVA | — | | | | | | | | | | | |
| | MAH-LLDPE | — | | | | | | | | | | | |
| | MAH-PP | — | | | | | | | | | | | |
| | AA-PP | — | | | | | | | | | | | |
| | EMAA | — | | | | | | | | | | | |
| | SEBS | — | | | | | | | | | | | |
| Ingredient | stNa | 270 | | | | | | | | 1.0 | 25.0 | | |
| C | stLi | 220 | | | | | | | | | | 1.0 | 25.0 |
| | stBa | >225 | 5.0 | | | | | | | | | | |
| | HstNa | 215 | | 5.0 | | | | | | | | | |
| | HstLi | 220 | | | 5.0 | | | | | | | | |
| | BeNa | >225 | | | | 5.0 | | | | | | | |
| | BeLi | 215 | | | | | 5.0 | | | | | | |
| | MoNa | 210 | | | | | | 5.0 | | | | | |
| | MoLi | 205 | | | | | | | 5.0 | | | | |
| | stCa | 148 | | | | | | | | | | | |
| | stZn | 125 | | | | | | | | | | | |
| | HstCa | 150 | | | | | | | | | | | |
| | MoCa | 135 | | | | | | | | | | | |
| | LaLi | >225 | | | | | | | | | | | |
| | stA | 70 | | | | | | | | | | | |
| | ERA | 83 | | | | | | | | | | | |
| | EBSA | 144 | | | | | | | | | | | |

| | | | | | | | | | | | |
|---|---|---|---|---|---|---|---|---|---|---|---|
| Flow-Starting | 229 | 233 | 220 | 225 | 223 | 215 | 198 | 238 | 230 | 227 | 201 |
| Temperature(° C.) | | | | | | | | | | | |
| Elastic Modulus (MPa) | 16.6 | 14.4 | 14.1 | 16.9 | 13.0 | 12.1 | 11.7 | 15.4 | 17.0 | 14.2 | 15.7 |
| 170° C. Deformation Rate(%) | 8.1 | 7.9 | 8.7 | 8.4 | 8.1 | 8.7 | 9.9 | 8.1 | 9.4 | 8.3 | 9.0 |
| 210° C. Deformation Rate(%) | 91.1 | 93.7 | 96.1 | 92.1 | 95.7 | 98.4 | 100 | 92.6 | 93.6 | 95.4 | 100 |
| Deformation Rate Ratio | 11.2 | 11.9 | 11.0 | 11.0 | 11.8 | 11.3 | 10.1 | 11.4 | 10.0 | 11.5 | 11.1 |
| (210° C./170° C.) | | | | | | | | | | | |
| Appearance of Sheet | A+ | A+ | A+ | A+ | A+ | A+ | A+ | A+ | A | A+ | A |

TABLE 2

| | | Melting | | | | | | | | | | |
|---|---|---|---|---|---|---|---|---|---|---|---|---|
| | | Point | | | | | | | | | | |
| | | (° C.) | B1 | B2 | B3 | B4 | B5 | B6 | B7 | B8 | B9 | B10 |
| Ingredient | Ca-AA | — | | | | | 5.0 | 5.0 | 5.0 | 5.0 | 5.0 | 5.0 |
| A | Zn-AA | — | | | | | | | | | | |
| | Al-AA | — | | | | | | | | | | |
| | Zr-AA | — | | | | | | | | | | |
| | ZnO | — | | | 5.0 | | | | | | | |
| | stCa | — | | | | 5.0 | | | | | | |
| Ingredient | MAH-SEBS | — | 100.0 | | 95.0 | 95.0 | | | 95.0 | | 90.0 | 90.0 |
| B | MAH-EO | — | | 100.0 | | | | | | 95.0 | | |
| | MAH-EMA | — | | | | | | | | | | |
| | MAH-EVA | — | | | | | | | | | | |
| | MAH-LLDPE | — | | | | | | | | | | |
| | MAH-PP | — | | | | | | | | | | |
| | AA-PP | — | | | | | | | | | | |
| | EMAA | — | | | | | 95.0 | | | | | |
| | SEBS | — | | | | | | 95.0 | | | | |
| Ingredient | stNa | 270 | | | | | | | | | | |
| C | stLi | 220 | | | | | | | | | | |
| | stBa | >225 | | | | | | | | | | |
| | HstNa | 215 | | | | | | | | | | |
| | HstLi | 220 | | | | | | | | | | |
| | BeNa | >225 | | | | | | | | | | |
| | BeLi | 215 | | | | | | | | | | |
| | MoNa | 210 | | | | | | | | | | |
| | MoLi | 205 | | | | | | | | | | |
| | stCa | 148 | | | | | | | | | 5.0 | |
| | stZn | 125 | | | | | | | | | | 5.0 |
| | HstCa | 150 | | | | | | | | | | |
| | MoCa | 135 | | | | | | | | | | |
| | LaLi | >225 | | | | | | | | | | |
| | stA | 70 | | | | | | | | | | |
| | ERA | 31 | | | | | | | | | | |
| | EBSA | 144 | | | | | | | | | | |
| Flow-Starting | | | 142 | 132 | 144 | 147 | 132 | 138 | 225 | 237 | 178 | 162 |
| Temperature('C) | | | | | | | | | | | | |
| Elastic Modulus (MPa) | | | 13.2 | 2.6 | 15.0 | 15.4 | 235 | 13.0 | 15.4 | 3.1 | 12.1 | 12.5 |
| 170° C. Deformation Rate(%) | | | 100 | 100 | 100 | 100 | 100 | 100 | 8.2 | 9.3 | 100 | 100 |
| 210° C. Deformation Rate(%) | | | 100 | 100 | 100 | 100 | 100 | 100 | 27.5 | 38.5 | 100 | 100 |
| Deformation Rate Ratio | | | 1.0 | 1.0 | 1.0 | 1.0 | 1.0 | 1.0 | 3.4 | 4.1 | 1.0 | 1.0 |
| (210° C./170° C.) | | | | | | | | | | | | |
| Appearance of Sheet | | | A+ | A+ | A+ | A | A | A+ | A+ | A+ | A+ | A+ |
| | | Melting | | | | | | | | | | |
| | | Point | | | | | | | | | | |
| | | (° C.) | B11 | B12 | B13 | B14 | B15 | B16 | B17 | B18 | B19 | B20 |
| Ingredient | Ca-AA | — | 5.0 | 5.0 | 5.0 | 5.0 | 5.0 | 5.0 | 5.0 | 5.0 | | |
| A | Zn-AA | — | | | | | | | | | | |
| | Al-AA | — | | | | | | | | | | |
| | Zr-AA | — | | | | | | | | | | |
| | ZnO | — | | | | | | | | | | |
| | stCa | — | | | | | | | | | | |
| Ingredient | MAH-SEBS | — | 90.0 | 90.0 | 90.0 | 90.0 | 90.0 | 90.0 | 80.0 | 65.0 | 95.0 | 95.0 |
| B | MAH-EO | — | | | | | | | | | | |
| | MAH-EMA | — | | | | | | | | | | |
| | MAH-EVA | — | | | | | | | | | | |
| | MAH-LLDPE | — | | | | | | | | | | |
| | MAH-PP | — | | | | | | | | | | |
| | AA-PP | — | | | | | | | | | | |
| | EMAA | — | | | | | | | | | | |
| | SEBS | — | | | | | | | | | | |
| Ingredient | stNa | 270 | | | | | | | | | | |
| C | stLi | 220 | | | | | | | | | 5.0 | |
| | stBa | >225 | | | | | | | | | | |
| | HstNa | 215 | | | | | | | | | | |
| | HstLi | 220 | | | | | | | | | | 5.0 |
| | BeNa | >225 | | | | | | | | | | |
| | BeLi | 215 | | | | | | | | | | |
| | MoNa | 210 | | | | | | | | | | |
| | MoLi | 205 | | | | | | | | | | |
| | stCa | 148 | | | | | | | | | | |
| | stZn | 125 | | | | | | | | | | |
| | HstCa | 150 | 5.0 | | | | | | | | | |
| | MoCa | 135 | | 5.0 | | | | | | | | |
| | LaLi | >225 | | | 5.0 | | | | | | | |
| | stA | 70 | | | | 5.0 | | | | | | |
| | ERA | 31 | | | | | 5.0 | | | | | |
| | EBSA | 144 | | | | | | 5.0 | 15.0 | 30.0 | | |

| | | | | | | | | | | |
|---|---|---|---|---|---|---|---|---|---|---|
| Flow-Starting | 180 | 169 | 235 | 166 | 215 | 224 | 218 | 205 | 144 | 343 |
| Temperature('C) | | | | | | | | | | |
| Elastic Modulus (MPa) | 11.0 | 10.5 | 17.5 | 11.5 | 13.5 | 18.4 | 19.2 | 19.5 | 14.6 | 14.9 |
| 170° C. Deformation Rate(%) | 100 | 100 | 8.3 | 100 | 10.0 | 9.4 | 9.5 | 9.8 | 100 | 100 |
| 210° C. Deformation Rate(%) | 100 | 100 | 100 | 100 | 40.0 | 35.5 | 41.5 | 43.3 | 100 | 100 |
| Deformation Rate Ratio | 1.0 | 1.0 | 12.0 | 1.0 | 4.0 | 3.8 | 4.4 | 4.4 | 1.0 | 1.0 |
| (210° C./170° C.) | | | | | | | | | | |
| Appearance of Sheet | A+ | A+ | B | B | A | A | A | A | A+ | A+ |

According to Table 1, each of samples A1 to A22 contained, as raw materials, ingredient A from which a metal ion was released upon heating, ingredient B composed of an organic polymer having an electron-withdrawing substituent group capable of forming an ionic bond with the metal ion in a side chain; and ingredient C composed of the compound having the structure represented by formula (1) mentioned above and having the melting point of 190° C. or higher, and the sample sheet obtained through crosslinking during kneading and press-forming had a flow starting temperature of 190° C. or higher. Each of samples A1 to A22 had the flow starting temperature, which was at least 5° C. higher than that of ingredient B, and therefore, it can be said that high heat resistance is obtained by crosslinking. Furthermore, since each of samples A1 to A22 had the flow starting temperature of 300° C. or lower, while a forming temperature of a general thermoplastic resin is around 300° C., it can be regarded as high re-moldability being obtained. Furthermore, each of samples A1 to A22 had the deformation rate of 90% or higher at 210° C. and 10% or lower at 170° C., and the deformation rate ratio was also 10 or more. Accordingly, it can be said that each of samples A1 to A22 can achieve both maintenance of the heat resistance at a temperature below 190° C. and improvement of the forming efficiency at a temperature of 190° C. or higher. Each sample had a favorable appearance (i.e., A or A+), without aggregates or separation of incompatibilities.

Samples A1 to A4 contained different types of metals from each other in ingredient A, while samples A1, A5 to A10 contained different types of ingredient B from each other. Furthermore, samples A1, A11 to A18 contained ingredient C different in structure from each other. In each case, high flow starting temperature, low elastic modulus, high deformation rate at 210° C. and high deformation rate ratio was obtained. However, among the samples that contained different types of ingredient B from each other, samples A9 and A10 had higher elastic modulus than the other samples, corresponding to the use of propylene-based modified resin. Comparing samples A1 and A11 having monovalent metals Na or Li in ingredient C, with sample A12 having bivalent metal Ba in ingredient C, samples A1 and A11 had slightly lower elastic modulus and higher deformation rate at 210° C., than sample A12. This may be because the metal contained in ingredient C was monovalent, and therefore, ingredient C was less likely to cause interactions to facilitate the crosslinking between the polymer chains of ingredient B in the crosslinked product. The content of ingredient C differed among samples A1, A19, and A20, and among samples A11, A21, and A22. Meanwhile, compared with samples A20 and A22, which contained as much as 25.0 parts by mass of ingredient C, samples A1, A19, A11, and A21, which contained a relatively small amount of ingredient C with the amount of 1.0 part by mass or 5.0 parts by mass, showed better results of appearance tests. This may be because the amount of ingredient C was kept small, and therefore, the aggregates of ingredient C were less likely to occur.

Unlike samples A1 to A22 mentioned above, samples B1 and B2 did not contain ingredient A, meaning that the crosslinking of ingredient B via a metal ion could not progress. Correspondingly the flow starting temperature was below 190° C. Furthermore, the 170° C. deformation rate was 100%, meaning that plastic deformation occurred. Thus, samples B1 and B2 had low heat resistance.

In samples B3 and B4, zinc oxide and calcium stearate were used, respectively, as ingredient A, rather than using a metal complex. These compounds did not release the metal ion even when heated, and therefore, they could not crosslink ingredient B. Correspondingly, the flow starting temperature of each of samples B3 and B4 was well lower than 190° C., which was almost the same as in sample B1. Furthermore, the 170° C. deformation rate was 100%, meaning that the plastic deformation occurred. Thus, the heat resistance of samples B3 and B4 was also low. The calcium stearate could also be classified as ingredient C.

In sample B5, ingredient B contained a carboxylic acid group, which is the electron-withdrawing group in a polymer main chain, but no-electron-withdrawing substituent group was contained in the side chain. The carboxylic acid group in the main chain can not form effectively a crosslinked structure via the ionic bond with the metal ion, due to steric hindrance of the adjacent methacryloyl group. Correspondingly, the flow starting temperature was well lower than 190° C. Furthermore, sample B5 had an elastic modulus as much as over 200 MPa. This may be because the crosslinked structure was formed at the main chain in ingredient B, and the degree of freedom of movement at a crosslinking site was considered to be low. Furthermore, the 170° C. deformation rate of sample B5 was also 100%, meaning that the plastic deformation occurred. This may be because a crosslinking density was low, and the heat resistance of the crosslinked product was not improved sufficiently.

In sample B6, ingredient B did not include a substituent group capable of forming the ionic bond with the metal ion, and a crosslinked structure could not be formed in ingredient B via the metal ion derived from ingredient A. Correspondingly, the flow starting temperature was well lower than 190° C. Furthermore, sample B6 could not obtain the effect of improvement of the heat resistance by the crosslinking, and the 170° C. deformation rate of sample B6 was 100%.

Samples B7 and B8 included, as raw materials, ingredient A from which the metal ion was released upon heating, and ingredient B composed of an organic polymer having an electron-withdrawing substituent group capable of forming the ionic bond with the metal ion in the side chain, and the crosslinked product was formed through crosslinking of ingredient B via the metal ion released from ingredient A upon heating. Corresponding to these facts, the flow starting temperature was well higher than 190° C. The 170° C. deformation rate was also kept 10% or lower, meaning that high heat resistance was obtained by crosslinking. However, neither of samples B7 and B8 contain ingredient C and could not obtain the effect of ingredient C that worked for improving fluidity of the crosslinked product by ingredient C. Furthermore, the 210° C. deformation rate was well below 50%, and the deformation rate ratio was as small as 5 or smaller. Therefore, in samples B7 and B8, the efficiency of the heat molding operation became low. Although the heat molding performed here was the press-forming into a sheet material, when extrusion molding was performed, it is impossible to accelerate the rate of extrusion due to low fluidity, resulting in low efficiency of the extrusion. Samples A1, A11 to A22 were those in which ingredient C was added to sample B7, and sample A5 was those in which ingredient C was added to sample B8. In both cases, the 210° C. deformation rate and deformation rate ratio were significantly improved, and a comparison with samples B7 and B8 showed that the addition of ingredient C works to improve significantly the heat deformability.

Ingredient C added to each sample B9 to B12 had the structure represented by formula (1) but had the melting point below 190° C. Each of samples B9 to B12, to which ingredient C was added, exhibited a significant improvement in the 210° C. deformation rate compared with sample B7, which did not contain ingredient C, meaning that ingredient C worked to improve the heat deformability. However, since the melting point of ingredient C was low, the heat deformability were improved unintentionally even at a temperature below 190° C., and the 170° C. deformation rate was the same value as the 210° C. deformation rate (i.e., 100%). The flow starting temperature was also below 190° C. Thus, the required heat resistance was not obtained.

Sample B13 employed lauric acid represented by m+n=9 in formula (1) as ingredient C. Since ingredient C was added, sample B13 obtained the effects of improvement of heat deformability, the 170° C. deformation rate as small as 10% or lower, and the deformation rate ratio as much as over 10. However, the appearance was evaluated as poor (i.e., “B”). It is considered that a short length of an alkyl chain of ingredient C lowered the compatibility of ingredient C with the crosslinked product formed from ingredients A and B, and the surface of the sheet material became uneven. When the extrusion molding was performed instead of the press-forming, the low compatibility affected further to a poor appearance.

Sample B14 employed the stearic acid, which was a molecule to which the hydrogen atom (i.e., H) was introduced, instead of the metal M of formula (1), as ingredient C. Since the stearic acid was added, sample B14 exhibited significant improvement in the 170° C. and 210° C. deformation rates and lowered flow starting temperature, similar to samples B9 to B12 to which ingredient C having a low melting point was added, compared to sample B7 to which ingredient C was not added. This may be because ingredient C had the melting point as low as 70° C. Here, the improvement in heat deformability here is presumably not caused by the formation of an anionic field, but rather by the behavior of stearic acid as a solvent, different from the case in which ingredient C has the structure represented by formula (1) having the metal M. Further, in sample B14, the appearance was evaluated as poor (i.e., “B”). This may be because some of the carboxyl groups in the stearic acid reacted with ingredient A to thereby separate from ingredient B, resulting in the formation of an uneven structure.

Samples B15 to B18 employed a molecule to which the amide group was introduced, instead of the metal M being introduced in formula (1). All the samples had a melting point of 150° C. or lower, meaning that they were melted at a temperature of kneading or forming; however, they did not form the anionic field even when they were melted, and therefore, they had the 210° C. deformation rates as low as 50% or lower, respectively. The deformation rate ratio was also as low as 5 or lower. Particularly, although samples B17 and B18 had an increased number of molecules having the amino group, compared with sample B16, the 210° C. deformation rate was only slightly increased. That is, even though the number of molecules to be added was increased, it is required to add the molecule that forms the anionic field to improve the heat deformability.

Since the polymer composition of each of samples B19 and B20 did not contain ingredient A, the crosslinking reaction of ingredient B did not occur, and the flow starting temperature of each of samples B19 and B20 was not significantly increased compared with that of ingredient B alone (i.e., sample B1). Although ingredient C was added, it did not work for releasing the metal ion even when it was heated. Therefore, ingredient C did not work for a metal-crosslinking of ingredient B instead of ingredient A. A similar feature was seen in sample B4, in which calcium stearate corresponding to ingredient C was employed as ingredient A. In sample B20, which had ingredient C having the hydroxyl group, ingredient C might interact with ingredient B and formed a bond, such as an ester bond; however, the reactivity in forming such a bond was low, and therefore, it was considered that the effect of crosslinking on reducing the fluidity of ingredient B was very low.

Finally, FIG. 3 illustrates the result of a status change of each composition by kneading, using the infrared absorption spectrum. FIG. 3 illustrates the difference spectrum obtained by subtracting the spectrum of the reference sample that did not contain ingredient C from each measurement sample obtained by kneading at 240° C. for one minute, three minutes, and five minutes, respectively. Furthermore, the spectrum of ingredient C alone is shown in dashed lines at the top of FIG. 3. As described above, the difference spectrum corresponds to the contribution of ingredient C extracted in each measurement sample.

As shown in the difference spectrum of each measurement sample, the measurement sample kneaded for one minute showed a similar spectrum (i.e., dashed lines) to that of ingredient C alone. However, as the kneading time increased, an absorption peaks at 1580 cm⁻¹ and 1560 cm⁻¹, and the absorption peaks at 1450 cm⁻¹ and 1400 cm⁻¹, which indicated the absorption of a metal salt, gradually changed to broad absorption peaks at 1660 to 1600 cm⁻¹ and 1490 to 1360 cm⁻¹, which correspond to an anionized state. This change indicates that the carboxylic acid constituting the metal salt in ingredient C formed an anionic field, and the field was delocalized over a broad range through the thermal kneading process.

Although some embodiments of the disclosure have been described in detail hereinbefore, the present disclosure is not limited thereto, and various modifications can be made without departing from the gist of the disclosure.

### LIST OF REFERENCE SIGNS

1 Insulated electric wire
2 Wire conductor
21 Elemental wire
3 Insulation coating

1. A crosslinkable polymer composition, comprising: ingredient A from which a metal ion is released upon heating;
ingredient B comprising an organic polymer having a side chain comprising an electron-withdrawing substituent group capable of forming an ionic bond with the metal ion released from ingredient A; and ingredient C comprising a secondary or tertiary amine having a structure represented by formula (1) below: 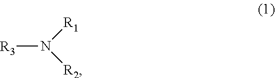
where R₁ represents a hydrogen atom or a hydrocarbon group having 30 or fewer carbon atoms; R₂ represents a hydrocarbon group having 30 or fewer carbon atoms; and R₃ represents a hydrocarbon group having 13 or more and 30 or fewer carbon atoms.

2. The crosslinkable polymer composition according to claim 1, wherein ingredient B forms a crosslinked product having a flow starting temperature of 190° C. or higher and 300° C. or lower when ingredient B is crosslinked via the metal ion released from ingredient A.

3. The crosslinkable polymer composition according to claim 1, wherein each of the hydrocarbon group as R₁, in a case where R₁ represents the hydrocarbon group, and the hydrocarbon groups as R₂ and R₃ in formula (1) above represents independently a linear alkyl group or an aromatic ring group.

4. The crosslinkable polymer composition according to claim 1, wherein ingredient B has a flow starting temperature of 50° C. or higher and 190° C. or lower.

5. The crosslinkable polymer composition according to claim 1, wherein ingredient A has a decomposition or phase transition temperature of 50° C. or higher and 300° C. or lower.

6. The crosslinkable polymer composition according to claim 1, wherein ingredient A has a decomposition or phase transition temperature equal to or higher than a flow starting temperature of ingredient B.

7. The crosslinkable polymer composition according to claim 1, wherein ingredient A is a metal complex comprising a ligand having a structure represented by formula (2) below: 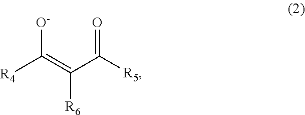
where each of R₄ and R₅ represents independently a hydrocarbon group having 1 to 8 carbon atoms, and R₆ represents a hydrogen atom or a hydrocarbon group having 1 to 8 carbon atoms, including a case where at least two among groups R₄, R₅, R₆ are interconnected by a ring structure.

8. The crosslinkable polymer composition according to claim 1, wherein the metal ion released from ingredient A is at least one selected from the group consisting of alkaline-earth metal, aluminum, zinc, titanium, and zirconium ions.

9. The crosslinkable polymer composition according to claim 1, wherein the substituent group of ingredient B is at least one selected from the group consisting of a carboxylic acid group, an acid anhydride group, a phosphoric acid group, and an acrylic acid group.

10. The crosslinkable polymer composition according to claim 1, wherein the substituent group of ingredient B is bonded to a main chain via an alkyl group or an alkylene group having one or more carbon atoms.

11. The crosslinkable polymer composition according to claim 1, wherein ingredient B has a glass transition temperature of 10° C. or lower.

12. The crosslinkable polymer composition according to claim 1, wherein ingredient B has a main chain comprising no electron-withdrawing group therein.

13. The crosslinkable polymer composition according to claim 1, wherein ingredient B has a main chain in the form of an olefin polymer or a styrene polymer.

14. The crosslinkable polymer composition according to claim 1, wherein the composition contains ingredient A in an amount of 0.1 part by mass or larger and 30 parts by mass or smaller with respect to 100 parts by mass of a total of ingredients A, B, and C.

15. The crosslinkable polymer composition according to claim 1, wherein the composition contains ingredient C in an amount of 0.5 parts by mass or larger and 20 parts by mass or smaller with respect to 100 parts by mass of the total of ingredients A, B, and C.

16. A crosslinked polymer material comprising:
a material formed by crosslinking of the crosslinkable polymer composition according to claim 1, comprising a crosslinked product in which ingredient B is crosslinked via the metal ion released from ingredient A; and
ingredient C.

17. The crosslinked polymer material according to claim 16, wherein the crosslinked polymer material has a tensile elastic modulus below 20 MPa.

18. An insulated electric wire, comprising:
a wire conductor; and
an insulation coating comprising the crosslinked polymer material according to claim 16, covering the wire conductor.

19. The insulated electric wire according to claim 18, wherein the wire conductor comprises a plurality of elemental wires twisted together, and the insulated wire has a flat portion where the wire conductor has a flat shape in a cross-section perpendicular to an axial direction of the insulated wire.

20. A wiring harness, comprising the insulated electric wire according to claim 18.
